(19) United States
(12) Patent Application Publication
(10) Pub. No.: US 2023/0379913 A1
(43) Pub. Date: Nov. 23, 2023

(54) METHOD AND APPARATUS FOR TRANSMITTING CONTROL SIGNAL IN A WIRELESS COMMUNICATION SYSTEM

(71) Applicant: Samsung Electronics Co., Ltd., Suwon-si (KR)

(72) Inventors: Donggu KIM, Suwon-si (KR); Woojae JEONG, Suwon-si (KR); Seunghyun LEE, Suwon-si (KR); Hanjin KIM, Suwon-si (KR); Juho LEE, Suwon-si (KR); Jungsoo JUNG, Suwon-si (KR)

(21) Appl. No.: 18/320,140

(22) Filed: May 18, 2023

(30) Foreign Application Priority Data
May 18, 2022 (KR) 10-2022-0061009

(51) Int. Cl. H04W 72/20

(52) U.S. Cl. CPC H04W 72/20

(57) ABSTRACT

The disclosure relates to a 5G or 6G communication system for supporting a higher data transmission rate beyond a 4th generation (4G) communication system, such as long term evolution (LTE). The disclosure relates to a method performed by a base station in a wireless communication system, which may include: transmitting a radio resource control (RRC) message including reconfigurable intelligence surface (RIS) codebook configuration information to an RIS controller; determining a format of RIS control information based on the number of RIS codeword indexes; generating the RIS control information based on the determined format; and transmitting the generated RIS control information to the RIS controller.

### CROSS-REFERENCE TO RELATED APPLICATION

This application is based on and claims priority under 35 U.S.C. § 119 to Korean Patent Application No. 10-2022-0061009, filed on May 18, 2022, in the Korean Intellectual Property Office, the disclosure of which is herein incorporated by reference in its entirety.

### BACKGROUND

### 1. Field

The disclosure relates to a method and an apparatus for transmitting a reconfigurable intelligent surface (RIS) control signal in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

A reconfigurable intelligence surface (RIS) means an intelligent reconfigurable antenna which controls and reconfigures, in real time, radio waves having reached the RIS corresponding to a wireless environment that is changed in real time. The RIS may reflect the radio waves having reached the RIS in a specific direction by forming a plurality of reflection patterns with combinations of phases and/or amplitudes of reflecting elements (REs) included on a reflection plane. In this case, in order for the RIS to form the reflection patterns, a base station is required to indicate reflection pattern information to a RIS controller (RC) in a symbol unit. However, in case that the base station indicates the reflection pattern information with respect to all symbols, an overhead of the control signal including the reflection pattern information may be increased. Accordingly, there is a need to reduce the overhead of the control signal by associating signals of specific channels with one another.

### SUMMARY

Based on the above-described discussions, the disclosure provides a method and an apparatus for reducing an overhead of reconfigurable intelligence surface (RIS) control information (RCI) in a wireless communication system.

A method performed by a base station in a wireless communication system according to the disclosure may include: transmitting a radio resource control (RRC) message including reconfigurable intelligence surface (RIS) codebook configuration information to an RIS controller; determining a format of RIS control information based on the number of RIS codeword indexes; generating the RIS control information based on the determined format; and transmitting the generated RIS control information to the RIS controller.

Further, a method performed by an RIS controller in a wireless communication system according to the disclosure may include: receiving an RRC message including RIS codebook configuration information from a base station; receiving RIS control information including a format indicator and information indicating a slot from the base station; identifying a format of the RIS control information based on the format indicator; identifying reflection patterns related to symbols of the slot based on the RIS control information; and controlling a reflection plane of an RIS based on the identified reflection patterns.

Further, a base station in a wireless communication system according to the disclosure may include: a transceiver; and a processor connected to the transceiver, wherein the processor is configured to: transmit an RRC message including RIS codebook configuration information to an RIS controller, determine a format of RIS control information based on the number of RIS codeword indexes, generate the RIS control information based on the determined format, and transmit the generated RIS control information to the RIS controller.

Further, an RIS controller in a wireless communication system according to the disclosure may include: a transceiver; and a processor connected to the transceiver, wherein the processor is configured to: receive an RRC message including RIS codebook configuration information from a base station, receive RIS control information including a format indicator and information indicating a slot from the base station, identify a format of the RIS control information based on the format indicator, identify reflection patterns related to symbols of the slot based on the RIS control information, and control a reflection plane of an RIS based on the identified reflection patterns.

The method and the apparatus according to embodiments of the disclosure can reduce the overhead of the reconfigurable intelligence surface (RIS) control information (RCI) in the wireless communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless communication system according to embodiments of the present disclosure;

FIG. 2 illustrates allocation of a physical downlink shared channel (PDSCH) according to embodiments of the present disclosure;

FIG. 3 illustrates reflection patterns according to embodiments of the present disclosure;

FIG. 4A illustrates reflection patterns according to embodiments of the present disclosure;

FIG. 4B illustrates reflection patterns according to embodiments of the present disclosure;

FIG. 4C illustrates reflection patterns according to embodiments of the present disclosure;

FIG. 5 illustrates an operation flow of a base station according to embodiments of the present disclosure;

FIG. 6 illustrates an operation flow of a reconfigurable intelligence surface (RIS) controller according to embodiments of the present disclosure;

FIG. 7 illustrates reflection patterns according to embodiments of the present disclosure;

FIG. 8A illustrates reflection patterns according to embodiments of the present disclosure;

FIG. 8B illustrates reflection patterns according to embodiments of the present disclosure;

FIG. 9 illustrates an operation flow of a base station according to embodiments of the present disclosure;

FIG. 10 illustrates an operation flow of an RIS controller according to embodiments of the present disclosure;

FIG. 11 illustrates reflection patterns according to embodiments of the present disclosure;

FIG. 12 illustrates reflection patterns according to embodiments of the present disclosure;

FIG. 13 illustrates the constitution of a base station according to embodiments of the present disclosure;

FIG. 14 illustrates the constitution of an RIS controller according to embodiments of the present disclosure; and

FIG. 15 illustrates the constitution of a UE according to embodiments of the present disclosure.

### DETAILED DESCRIPTION

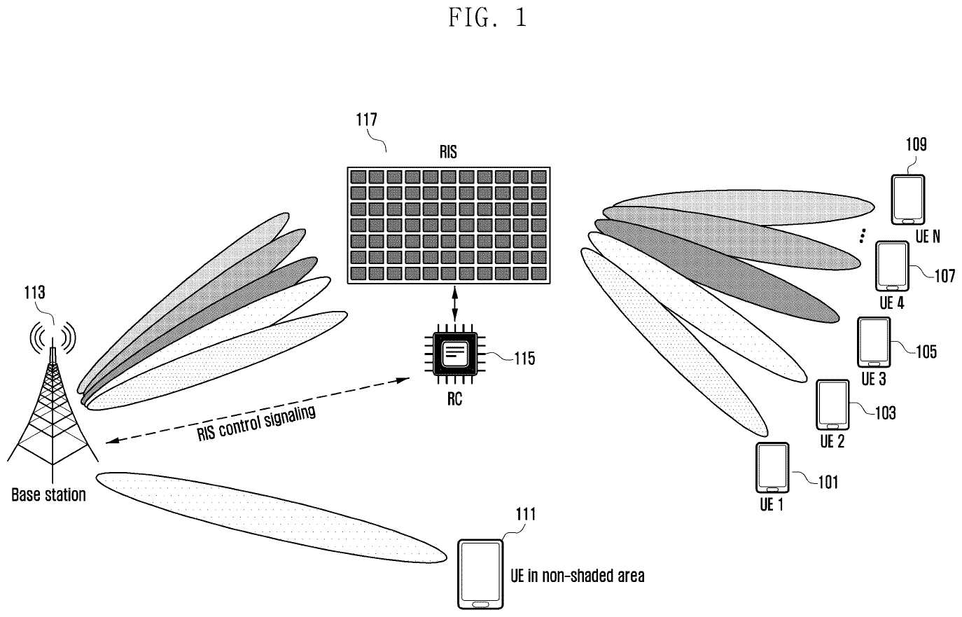

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operation principle of the disclosure will be described in detail with reference to the accompanying drawings. The terms used in the disclosure are used merely to explain a specific embodiment, but are not intended to limit the scope of other embodiments. Unless clearly differently meant in context, the singular expression may include the plural expression. Terms used in the disclosure may have the same meaning as that generally understood by those of ordinary skill in the technical field related to the disclosure. Among the terms used in the disclosure, the terms defined in general dictionaries may be interpreted as the same or similar meanings as or to the meanings in context of the related technologies, and unless clearly defined in the disclosure, the terms are not interpreted as overly formal meanings. In some cases, even the terms defined in the disclosure cannot be interpreted to exclude embodiments of the disclosure.

Further, in the disclosure, although the expression “exceeding” or “less than” has been used to judge whether a specific condition is satisfied or fulfilled, this is merely to express an example, but does not exclude the description “not less than” or “ not more than.” Further, the condition described as “not less than” may be replaced by “exceeding,” and the condition described as “not more than” may be replaced by “less than.”

Further, in the disclosure, although embodiments have been explained by using the terms that are used in the long term evolution (LTE) and new radio (NR) being defined in some communication standards (e.g., 3rd generation partnership project (3GPP)), they are merely exemplary for explanation. The embodiments of the disclosure can be easily modified and applied to other communication systems.

Hereinafter, a method and an apparatus for configuring a reconfigurable intelligence surface (RIS) control signal according to embodiments of the disclosure will be described in more detail with reference to the accompanying drawings.

FIG. 1 illustrates a wireless communication system according to embodiments of the present disclosure. FIG. 1 exemplifies one or more UEs 101, 103, 105, 107, 109, and 111, a base station 113, an RIS controller (RC) 115, and an MS 117 as some of nodes of the wireless communication system.

With reference to FIG. 1, one or more UEs 101, 103, 105, 107, 109, and 111 may or may not receive signals transmitted from the base station 113 in accordance with their locations. For example, the UE 111 in a non-shaded area may receive the signal transmitted from the base station 113 (e.g., line of sight (LoS)). As another example, the UEs 101, 103, 105, 107, and 109 may not receive the signals from the base station 113 (e.g., non-line of sight (nLoS)). In this case, the RIS 117 may be used for the UEs 101, 103, 105, 107, and 109 that are unable to receive the signals directly from the base station 113. However, the embodiments of the disclosure are not limited to such examples, and the RIS 117 may be used even for the UE 111 that can directly receive the signal from the base station 113.

The reconfigurable intelligence surface (MS) 117 may reflect the signals received from the base station in a specific direction by forming one or more reflection patterns with combinations of phases and/or amplitudes of reflecting elements (REs) included on a reflection plane. That is, the MS 117 may transfer, to the UEs 101, 103, 105, 107, and 109, a control signal received on a signal (e.g., physical downlink control channel (PDCCH)) received from the base station, a data signal received on a physical downlink shared channel (PDSCH)), a synchronization signal, and a reference signal by forming the reflection patterns by the plurality of REs based on the control signal received from the base station 113. Further, the RIS 117 may transfer, to the base station 113, a signal received on a signal (e.g., physical uplink control channel (PUCCH)) received from the UEs 101, 103, 105, 107, and 109, a signal received on a physical uplink shared channel (PUSCH), and a preamble received on a physical random access channel (PRACH) by forming the reflection patterns by the plurality of REs based on the received control signal.

In this case, the RIS controller 115 may control the RIS 117 to form specific reflection patterns. According to an embodiment, the RIS controller 115 may be physically attached to the RIS 117 and may control the RIS 117. According to another embodiment, the RIS controller 115 may control the RIS 117 through the control signal in a place that is physically away from the RIS 117. However, this is merely exemplary, and a method in which the RIS controller 115 controls the RIS 117 is not limited thereto.

First, in order to control the RIS 117, the RIS controller 115 may receive configuration information on a RIS codebook from the base station. The configuration information on the RIS codebook may include information on a plurality of reflection patterns that can be formed by the RIS 117. For example, if a reflection plane of the RIS 117 includes N REs, and the number of reflection patterns that can be formed by one RE is M, the reflection patterns as in Mathematical expression 1 below may be formed. Here, a set of the formed reflection patterns may be referred to as the RIS codebook.

Φₘ={β_{m,1}e^{jθ}^{_{m,1}}, β_{m,2}^{jθ}^{_{m,2}}, . . . , β_{m,N}e^{jθ}^{_{m,N}}}, m=1,2, . . . , M (1)

In the mathematical expression 1, M may represent the number of RIS codeword indexes. For example, in case of M=8, one RE may form 8 reflection patterns. Further, m may mean the RIS codeword indexes. Further, β may represent the amplitude of the reflection pattern. For example, β_{m,2} may represent that the amplitude of the second RE corresponds to the amplitude of the m-th reflection pattern among M reflection patterns. Further, θ may represent the phase of the reflection pattern. For example, θ_{m,2} may represent that the phase of the second RE corresponds to the phase of the m-th reflection pattern among M reflection patterns.

The configuration information on the RIS codebook may include RIS codeword indexes m and information on the plurality of reflection patterns corresponding to the RIS codeword indexes. In this case, the information on the plurality of reflection patterns may include amplitude information and phase information being applied to the respective REs. The base station 113 may transmit, to the RIS controller 115, the configuration information on the RIS codebook through upper layer signaling (e.g., radio resource control (RRC)). The RIS controller 115 may receive control information from the base station in order to control the RIS 117 to form reflection patterns corresponding to one of a plurality of RIS codewords. Here, the control information may be referred to as RIS control information (RCI) being received through a newly defined physical channel or RIS dedicated channel. However, the control information is not limited thereto, and a new field for indicating the reflection pattern to downlink control information (DCI) of the existing physical downlink control channel (PDCCH) may be defined. It will be described in detail below that the RIS controller 115 controls to form the reflection patterns corresponding to the RIS codewords indicated through the control information.

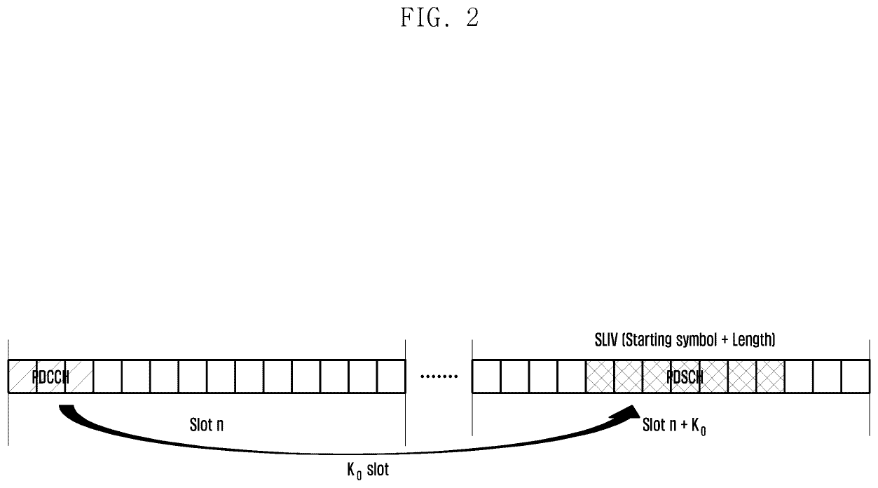

FIG. 2 illustrates PDSCH allocation according to embodiments of the present disclosure. In FIG. 2, the number of bits for indicating time resources of a physical downlink shared channel (PDSCH) through control information will be described.

With reference to FIG. 2, the RIS controller 115 may receive the control information from the base station 113. The control information may include at least one of information on a slot offset or information on a start symbol and a length of a PDSCH (e.g., start symbol and length indicator value (SLIV)).

According to an embodiment, a slot offset K0may mean a difference in the slot number between a slot allocated with a PDCCH and a slot allocated with a PDSCH being scheduled by the PDCCH. For example, the slot offset may have one value of 0 to 32. Accordingly, information on the slot offset may be composed of 6-bit information. For example, if the slot offset is 1, the information on the slot offset may be composed of bits of 000001. However, this is merely exemplary, and the range of the slot offset may be diversely configured depending on cases.

According to an embodiment, the start symbol and the length of the PDSCH may mean the start symbol allocated with the PDSCH and the number of sequential symbols in the slot indicated by the slot offset. For example, in case that a normal cyclic prefix (CP) is used, 14 symbols may exist in one slot, and thus possible combinations of start symbols S of the PDSCH and the symbol lengths L of the PDSCH may be as in Table 1 below.

TABLE 1

| PDSCH start symbol (S) | PDSCH symbol length (L) |
|---|---|
| 0 | One value of 1 to 14 |
| 1 | One value of 1 to 13 |
| 2 | One value of 1 to 12 |
| 3 | One value of 1 to 11 |
| 4 | One value of 1 to 10 |
| 5 | One value of 1 to 9 |
| 6 | One value of 1 to 8 |
| 7 | One value of 1 to 7 |
| 8 | One value of 1 to 6 |
| 9 | One value of 1 to 5 |
| 10 | One value of 1 to 4 |
| 11 | One value of 1 to 3 |
| 12 | One value of 1 to 2 |
| 13 | 1 |

With reference to Table 1, the number of possible combinations of the start symbols S of the PDSCH and the symbol lengths L of the PDSCH is 105. Accordingly, 7-bit information is required to indicate the combinations of the PDSCH start symbols S and the symbol lengths L of the PDSCH. In this case, the SLIV may be calculated in accordance with Mathematical expression 2 below.

if (L−1)≤7, SLIV=14×(L−1)+s,

else SLIV=14×(14−L+1)+(14−1−S) (2)

For example, with reference to FIG. 2, in case of S=4 and L=7, the SLIV becomes SLIV=88. Accordingly, the information on the start symbols and the lengths of the PDSCH may be composed of bits of 1011000.

As a result, the information of total 13 bits may be required to indicate the time resources of the PDSCH.

### [Embodiment 1]

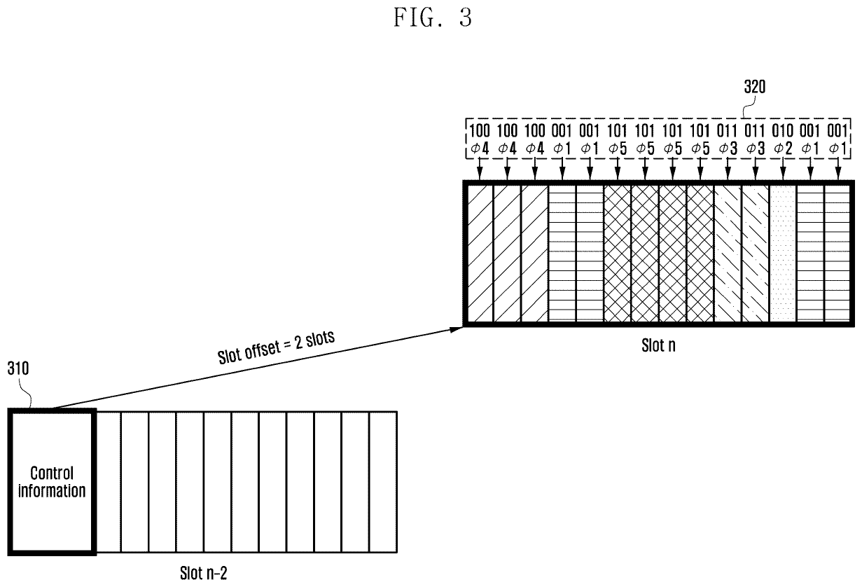

FIG. 3 illustrates reflection patterns according to embodiments of the present disclosure. With reference to FIG. 3, the number of bits required for the control information 310 to indicate the reflection patterns 320 will be described. In FIG. 3, it is assumed that a slot offset has one value of 0 to 32, and the number of RIS codeword indexes is 8.

With reference to FIG. 3, control information 310 may include information on the slot offset and information on reflection patterns of symbols. Here, the control information 310 may be referred to as MS control information (RCI).

First, the slot offset may mean a difference in the slot number between the slot in which the control information 310 is received and the slot to which the reflection patterns are applied. For example, with reference to FIG. 3, since the slot in which the control information 310 is received is slot n-2, and the slot offset is 2, it may mean that the reflection patterns indicated by the control information 310 are applied in slot n. In this case, since the slot offset is 2, the information on the slot offset may be composed of bits of 000010. That is, the information on the slot offset may be composed of 6-bit information. However, in this case, it is exemplified that the maximum value of the slot offset is 32, and in case that the slot offset has one value of 0 to KRCI-1, the information on the slot offset may be composed of information of ┌log₂K_{RCI}┐ bits.

The reflection patterns 320 of the symbols may mean the reflection patterns being applied to the respective symbols in the slot indicated by the slot offset. That is, the reflection patterns being applied in the respective symbols may be identified in accordance with the RIS codeword indexes indicated by the RIS control information. For example, with reference to FIG. 3, the reflection patterns as in Table 2 below may be applied from symbol 0 to symbol 13.

TABLE 2

| Symbol | Reflection pattern | Bits |
|---|---|---|
| 0 | φ₄ | 100 |
| 1 | φ₄ | 100 |
| 2 | φ₄ | 100 |
| 3 | φ₁ | 001 |
| 4 | φ₁ | 001 |
| 5 | φ₅ | 101 |
| 6 | φ₅ | 101 |
| 7 | φ₅ | 101 |
| 8 | φ₅ | 101 |
| 9 | φ₃ | 011 |
| 10 | φ₃ | 011 |
| 11 | φ₂ | 010 |
| 12 | φ₁ | 001 |
| 13 | φ₁ | 001 |

Accordingly, with reference to FIG. 3 and Table 2, the information on the reflection patterns 320 of the symbols may be composed of bits of 100100100001001101101101101011011010001001. That is, the information on the reflection patterns 320 of the symbols may be composed of 42-bit information. However, in this case, it is exemplified that the number of RIS codeword indexes is 8, and if the number of MS codeword indexes is M, the information on the reflection patterns 320 of the symbols may be composed of information of 14·┌log₂M┐ bits.

With reference to the above-described matters, in order to indicate the reflection patterns being applied to the symbols of a specific slot through the RIS control information 310, information of ┌log₂K_{RCI}┐+14·┌log₂M┐ bits is required. The format of the MS control information generated in the described method with reference to FIG. 3 may be referred to as format 1.

In consideration of the point that the MS control information 310 is generally transmitted through layer 1 (L1) signaling, it is required to reduce overhead of pieces of information included in the MS control information 310. In case of generating the MS control information 310 in accordance with the above-described format 1, implementation complexity may be reduced, but in a specified case, the overhead of the RIS control information 310 may be excessive.

Hereinafter, in consideration of the point that related physical channels mostly perform communication by using the same beam in a wireless communication environment and timing relation is defined between the physical channels, schemes for reducing the overhead of the MS control information 310 rather than format 1 in a specified case will be described.

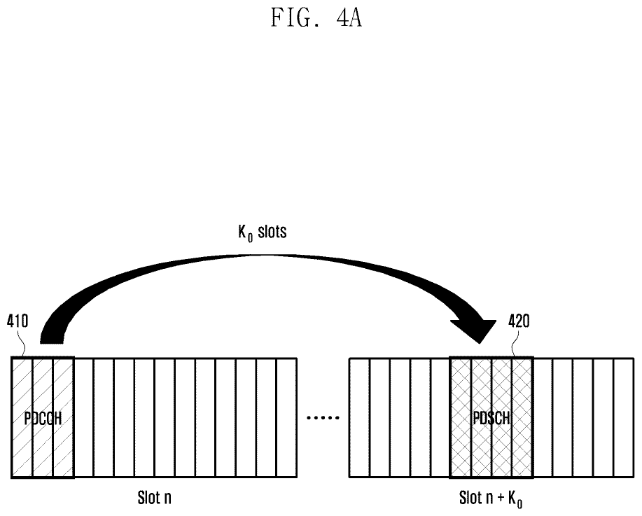

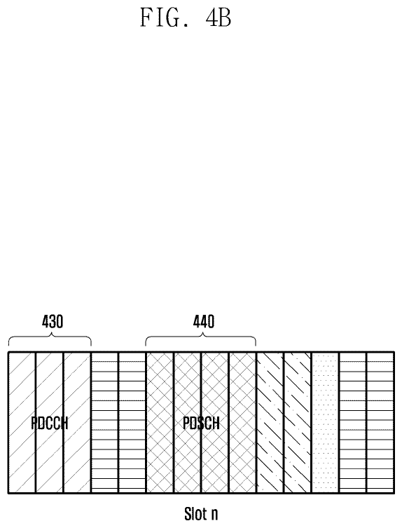

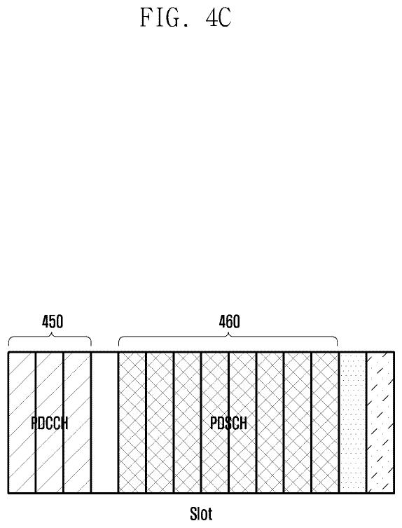

FIG. 4A illustrates reflection patterns according to embodiments of the present disclosure. With reference to FIG. 4A, the number of bits required to indicate reflection patterns of slot n will be described. That is, since PDSCH 420 being scheduled by PDCCH 410 and PDSCH 420 mostly use the same beam, the number of required bits in case that the same reflection pattern is applied to the PDCCH 410 and the PDSCH 420 will be described. Meanwhile, although not illustrated in FIG. 4A, it is assumed that the RIS control information (RCI) is received before slot n. Further, it is assumed that the PDSCH allocated to slot n has already been indicated so that the same reflection pattern as that of the PDCCH that schedules the corresponding PDSCH is applied thereto.

The RIS control information may include information on a slot offset, information representing a time resource of the PDCCH 410, information representing a time resource of the PDSCH 420, information on the reflection patterns being applied to the PDCCH 410 and the PDSCH 420, and information on the reflection patterns being applied to the symbols except the PDCCH 410 allocated to slot n and the PDSCH scheduled to slot n.

First, the slot offset may mean the difference in the slot number between the slot in which the MS control information is received and the slot to which the reflection patterns are applied. In this case, if the range of the slot offset is 0 to KRCI-1, the information on the slot offset for the reflection patterns may be composed of ┌log₂K_{RCI}┐ bits.

The information representing the time resource of the PDCCH 410 may represent the time resource to which the PDCCH is allocated in the slot indicated by the slot offset. For example, if the start symbol of the PDCCH in one slot has one value of 0 to 13, and the symbol length of the PDCCH has one value of 1 to 3, possible combinations of the start symbols S of the PDCCH and the symbol lengths L of the PDCCH may be as in Table 3 below.

TABLE 3

| PDCCH start symbol (S) | PDCCH symbol length (L) |
|---|---|
| 0 | One value of 1 to 3 |
| 1 | One value of 1 to 3 |
| 2 | One value of 1 to 3 |
| 3 | One value of 1 to 3 |
| 4 | One value of 1 to 3 |
| 5 | One value of 1 to 3 |
| 6 | One value of 1 to 3 |
| 7 | One value of 1 to 3 |
| 8 | One value of 1 to 3 |
| 9 | One value of 1 to 3 |
| 10 | One value of 1 to 3 |
| 11 | One value of 1 to 3 |
| 12 | One value of 1 to 2 |
| 13 | 1 |

With reference to Table 3, the number of possible combinations of start symbols S of the PDCCH and the symbol lengths L of the PDCCH is 39. Accordingly, the combination of the start symbols S of the PDCCH and the symbol lengths L of the PDCCH may be composed of 6-bit information. In this case, the value representing the time resource of the PDCCH may be calculated in accordance with Mathematical expression 3 below.

PDCCHₚₒₛᵢₜᵢₒₙ=3×S+(L−1) (3)

For example, with reference to FIG. 4A, since S=0 and L=3, the position of the PDCCH is PDCCHposition=2. Accordingly, the information on the PDCCH time resource may be composed of 000010 that are 6 bits.

As illustrated in FIG. 2, the information on the time resource of the PDSCH 420 may be composed of 13-bit information.

The information on the reflection patterns being applied to the PDCCH 410 and the PDSCH 420 may be composed of ┌log₂M┐-bit information.

The reflection pattern information on the symbols except the PDCCH 410 allocated to slot n and the PDSCH being scheduled to slot n may be composed of (14−α·┐log₂M┐-bit information. In this case, α may mean the number of symbols allocated to the PDCCH 410 and the PDSCH scheduled to slot n. Further, M may mean the number of RIS codeword indexes.

To summarize the above-described contents, in order to indicate the reflection patterns of the symbols included in slot n through the RIS control information, ┌log₂K_{RCI}┐+19+(15−α)·┌log₂M┐-bit information is required. In order to distinguish from format 1 as described above in FIG. 3, the format of the MS control information generated in the above-described method of FIG. 4A may be referred to as format 2.

FIG. 4B illustrates reflection patterns according to embodiments of the present disclosure. In FIG. 4B, if the number α of symbols of PDCCH 430 and PDSCH 440 allocated to slot n is 7, and the number of RIS codeword indexes is 8, overheads of the MS control information (RCI) of format 1 and format 2 are compared with each other.

As illustrated in FIG. 3, the MS control information of format 1 may include ┌log₂K_{RCI}┐+14·┌log₂M┐-bit information. Further, as illustrated in FIG. 4A, the control information of format 2 may include ┌log₂K_{RCI}┐+19+8·┌log₂M┐-bit information. In this case, the number of required bits in accordance with the number M of MS codeword indexes is represented as in Table 4 below.

TABLE 4

| | The number of bits of | The number of bits of |
|---|---|---|
| The number of RIS | RIS control | RIS control |
| codeword indexes | information of format 1 | information of format 2 |
| 4 < M ≤ 8 | ┌log₂K_{RCI}┐ + 42 | ┌log₂K_{RCI}┐ + 43 |
| 8 < M ≤ 16 | ┌log₂K_{RCI}┐ + 56 | ┌log₂K_{RCI}┐ + 51 |
| 16 < M ≤ 32 | ┌log₂K_{RCI}┐ + 70 | ┌log₂K_{RCI}┐ + 59 |
| 32 < M ≤ 64 | ┌log₂K_{RCI}┐ + 84 | ┌log₂K_{RCI}┐ + 67 |

With reference to Table 4, if the number M of MS codeword indexes is equal to or smaller than 8, the overhead of the MS control information of format 1 may be lower than the overhead of the MS control information of format 2. In contrast, if the number M of RIS codeword indexes exceeds 8, the overhead of the MS control information of format 2 may be lower than the overhead of the MS control information of format 1. That is, it may be advantageous in reducing the overhead to generate the MS control information of format 2 as the number M of MS codeword indexes is larger.

FIG. 4C illustrates reflection patterns according to embodiments of the present disclosure. In FIG. 4C, if the number α of symbols of PDCCH 450 and PDSCH 460 allocated to slot n is 11, and the number of MS codeword indexes is 8, overheads of the RIS control information (RCI) of format 1 and format 2 are compared with each other.

As described above with reference to FIG. 3, the RIS control information of format 1 may include ┌log₂K_{RCI}┐+14·┌log₂M┐-bit information. Further, as described above with reference to FIG. 4A, the control information of format 2 may include ┌log₂K_{RCI}┐+19+4·┌log₂M┐-bit information. In this case, the number of bits required in accordance with the number M of MS codeword indexes is represented as in Table 5 below.

TABLE 5

| | The number of bits of | The number of bits of |
|---|---|---|
| The number of RIS | RIS control | RIS control |
| codeword indexes | information of format 1 | information of format 2 |
| 4 < M ≤ 8 | ┌log₂K_{RCI}┐ + 42 | ┌log₂K_{RCI}┐ + 31 |
| 8 < M ≤ 16 | ┌log₂K_{RCI}┐ + 56 | ┌log₂K_{RCI}┐ + 35 |
| 16 < M ≤ 32 | ┌log₂K_{RCI}┐ + 70 | ┌log₂K_{RCI}┐ + 39 |
| 32 < M ≤ 64 | ┌log₂K_{RCI}┐ + 84 | ┌log₂K_{RCI}┐ + 43 |

With reference to Table 5, the overhead of the RIS control information of format 2 is lower than the overhead of the RIS control information of format 2 regardless of the number M of MS codeword indexes. That is, it may be advantageous for format 2 to reduce the overhead of the MS control information as the number α of symbols of the PDCCH and PDSCH allocated to slot n is larger. As described above with reference to FIGS. 4B and 4C, it may be advantageous for one of format 1 or format 2 to reduce the overhead of the RIS control information based on the number M of RIS codeword indexes and the number α of symbols of the PDCCH and PDSCH allocated to the slot. Accordingly, hereinafter, a method for adaptively determining the format of the MS control information based on the number M of RIS codeword indexes and the number α of symbols of the PDCCH and PDSCH allocated to the slot will be described.

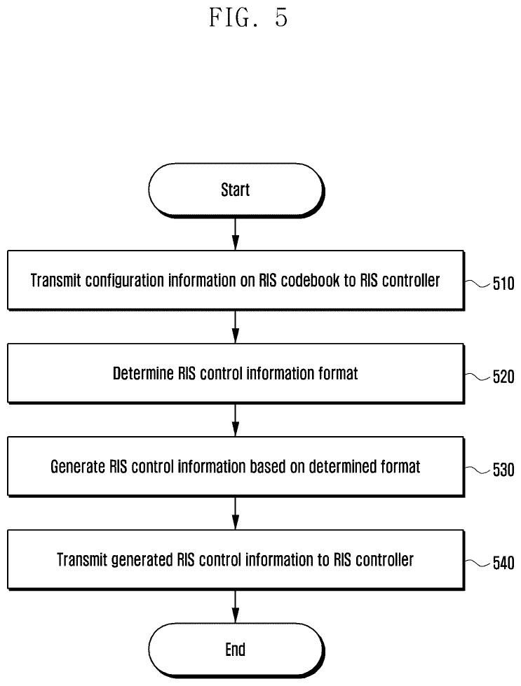

FIG. 5 illustrates an operation flow of a base station according to embodiments of the present disclosure. With reference to FIG. 5, a method for configuring an MS controller (RC) by a base station so that the RIS controller can control reflection patterns of an MS will be described.

With reference to FIG. 5, in step 510, the base station may transmit configuration information on an MS codebook to the MS controller. The configuration information on the MS codebook may include at least one of pieces of information on MS codeword indexes or a plurality of reflection patterns corresponding to the MS codeword indexes. In this case, the information on the plurality of reflection patterns may include at least one of information on amplitudes or information on phases being applied to respective REs. For example, if a reflection plane of the MS includes 4 reflection elements (REs), and the number of RIS codeword indexes is 4, the configuration information on the RIS codebook may be configured as in Table 6 below.

TABLE 6

| RIS codeword index | Reflection pattern information |
|---|---|
| 0 | {β [symbol] ,β [symbol] ,β [symbol] ,β [symbol] } |
| 1 | {β [symbol] ,β [symbol] ,β [symbol] ,β [symbol] } |
| 2 | {β [symbol] ,β [symbol] ,β [symbol] ,β [symbol] } |
| 3 | {β [symbol] ,β [symbol] ,β [symbol] ,β [symbol] } |

[symbol]

indicates data missing or illegible when filed

In step 520, the base station may determine an RIS control information format. In this case, the RIS control information format may be determined based on the number α of symbols allocated to a control channel (e.g., physical downlink control channel (PDCCH)) and a data channel (e.g., physical downlink shared channel (PDSCH)) and the number M of RIS codeword indexes. In order to indicate the format of the RIS control information, one-bit information may be additionally required. For example, if the information indicating the format of the RIS control information is 0, it may represent that the RIS control information has been generated based on format 1. Further, if the information indicating the format of the RIS control information is 1, it may represent that the RIS control information has been generated based on format 2. In consideration of such added one bit, the number of bits required in the respective formats may be as in Table 7 below.

TABLE 7

| Format | The number of bits |
|---|---|
| Format 1 | ┌log₂K_{RCI}┐ + 14 · ┌log₂M┐ + 1 |
| Format 2 | ┌log₂K_{RCI}┐ + 20 + (15 − α) · ┌log₂M┐ |

Accordingly, if format 2 is more advantageous than format 1 in reducing the overhead, it may be a case in which Mathematical expression 4 below is satisfied.

$$α > \frac{19}{⌈ {log}_{2} M ⌉} + 1 \qquad [ Mathematical expression 4 ]$$

Finally, if Mathematical expression 4 is not satisfied, the base station may determine to generate the MS control information of format 1. In contrast, if Mathematical expression 4 is satisfied, the base station may determine to generate the RIS control information of format 2.

In step 530, the base station may generate the RIS control information based on the determined format.

According to an embodiment, if the RIS control information is generated based on format 1, the RIS control information may include the following information.
Slot offset (┌log₂K_{RCI}┌ bits): The slot offset may indicate a difference in the slot number between the slot in which the RIS control information is received and the slot to which the reflection patterns are applied.
RIS control information format indicator (1 bit): The RIS control information format indicator may indicate the RIS control information format. For example, if the RIS control information format indicator is 0, the RIS controller may identify that the RIS control information is generated based on format 1. Further, if the RIS control information format indicator is 1, the RIS controller may identify that the RIS control information is generated based on format 2. However, this is merely exemplary, and the opposite case may also be possible.
Information indicating reflection patterns of symbols (14·┌log₂M┐ bits): The information may include reflection pattern information being applied to symbols included in the slot indicated by the slot offset. One of M RIS codeword indexes may be indicated in each symbol.

According to an embodiment, in case that the RIS control information is generated based on format 2, the RIS control information may include the following information.
Slot offset (┌log₂K_{RCI}┐ bits): The slot offset may indicate a difference in the slot number between the slot in which the RIS control information is received and the slot to which the reflection patterns are applied.
RIS control information format indicator (1 bit): The RIS control information format indicator may indicate the RIS control information format. For example, if the RIS control information format indicator is 0, the RIS controller may identify that the RIS control information is generated based on format 1. Further, if the RIS control information format indicator is 1, the RIS controller may identify that the RIS control information is generated based on format 2. However, this is merely exemplary, and the opposite case may also be possible.
Information representing the time resource of the PDCCH (6 bits): The information representing the time resource of the PDCCH may represent the time resource on which the PDCCH is allocated in the slot indicated by the slot offset.
Information representing the time resource of the PDSCH (13 bits): The information representing the time resource of the PDSCH may represent the time resource allocated to the PDSCH scheduled by the PDCCH.
Information on the reflection patterns being applied to the control channel and the data channel bits): The information on the reflection patterns being applied to the control channel and the data channel may indicate the reflection patterns commonly applied to the control channel and the data channel. That is, the information may indicate the reflection patterns commonly applied to the PDCCH and the PDSCH being scheduled by the PDCCH.
Information on the reflection patterns being applied to the symbols except the symbols allocated to the control channel and the data channel ((14−α)·┌log₂M┐ bits): The information may indicate the reflection patterns being applied to the remaining symbols except the symbols allocated to the control channel and the data channel in the slot indicated by the slot offset. For example, if the slot n is indicated by the slot offset, the information may indicate the reflection patterns being applied to the remaining symbols except the symbols allocated to the PDCCH and the PDSCH in the slot n.

According to an embodiment, the RIS control information being generated based on format 2 may further include the following information. That is, in order to apply the reflection patterns of the PDCCH and the PDSCH even on the time resource on which a hybrid automatic repeat request-acknowledgement (HARQ-ACK) for the PDSCH is received, the following information for indicating the time resource on which the HARQ-ACK information is transmitted may be further included.
HARQ-ACK correlation indicator (1 bit): The HARQ-ACK correlation indicator may represent whether the RIS control information includes HARQ-ACK time resource information (e.g., PDSCH-HARQ feedback timing indicator and time resource information of PUCCH). For example, the HARQ-ACK correlation indicator that is set to 0 may represent that the RIS control information does not include the HARQ-ACK time resource information. Further, the HARQ-ACK correlation indicator that is set to 1 may represent that the RIS control information includes the HARQ-ACK time resource information. However, this is merely exemplary, and the opposite case may also be possible. Finally, if the RIS control information format indicator and the HARQ-ACK correlation indicator are set to 1 in all, the RIS controller may expect that the RIS control information includes the HARQ-ACK time resource information.
PDSCH-HARQ feedback timing indicator (4 bits): The PDSCH-HARQ feedback timing indicator may indicate a slot offset K1. In this case, the slot offset K1 may mean the difference in the slot number between the slot allocated with the PDSCH and the slot allocated with the HARQ-ACK information for the PDSCH. For example, the slot offset K1 may have one value of 0 to 15. Accordingly, the PDSCH-HARQ feedback timing indicator may be composed of 4-bit information. For example, if the slot offset K1 is 2, the PDSCH-HARQ feedback timing indicator may be composed of bits of 0010. However, this is merely exemplary, and the range of the slot offset K1 may be variously defined in some cases.
PUCCH time resource information (7 bits): The PUCCH time resource information may indicate the time resource on which the HARQ-ACK information is allocated in the slot indicated by the PDSCH-HARQ feedback timing indicator. In this case, the number of possible combinations of start symbols (e.g., S=0, 1, . . . , 13) and symbol lengths (e.g., L=1, 2) defined in format 0 and format 2 of the PUCCH is 27, and the number of possible combinations of start symbols (e.g., S=0, 1, . . . , 10) and symbol lengths (e.g., L=4, 5, . . . , 14) defined in PUCCH formats 1, 3, and 4 is 66. Finally, since the number of possible combinations of the start symbols and the symbol lengths that can be allocated to the PUCCH is 93, the PUCCH time resource information may be composed of 7-bit information. However, this is merely exemplary, and the range of the start symbols and the symbol lengths of the PUCCH may be variously defined in some cases.

In step 540, the base station may transmit the generated RIS control information to the RIS controller.

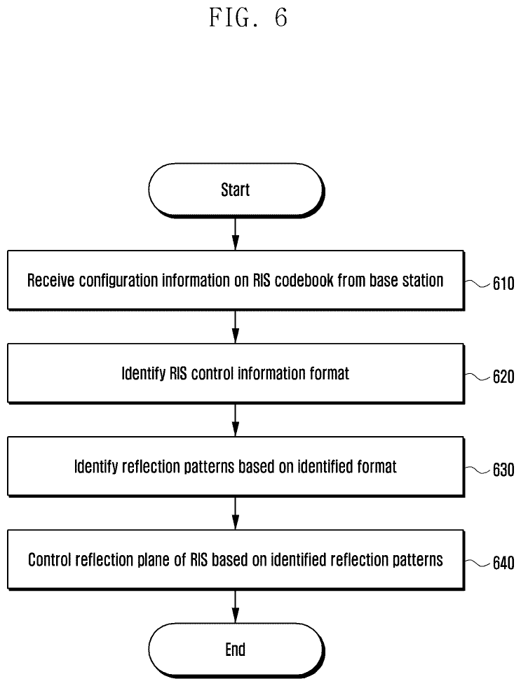

FIG. 6 illustrates an operation flow of an MS controller according to embodiments of the present disclosure. With reference to FIG. 6, a method for controlling RIS reflection patterns by an MS controller (RC) will be described.

In step 610, the RIS controller may receive configuration information on an MS codebook from the base station. The configuration information on the RIS codebook may include at least one of pieces of information on RIS codeword indexes or a plurality of reflection patterns corresponding to the RIS codeword indexes. In this case, the information on the plurality of reflection patterns may include at least one of information on amplitudes or information on phases being applied to respective REs.

In step 620, the RIS controller may identify the format of the RIS control information. The RIS controller may receive the RIS control information from the base station. The RIS controller may identify the format of the RIS control information based on the RIS control information format indicator included in the RIS control information. Here, the format of the RIS control information may be composed of one bit. For example, if the RIS control information format indicator is 0, the RIS controller may identify that the format of the RIS control information is format 1. Further, if the RIS control information format indicator is 1, the RIS controller may identify that the format of the RIS control information is format 2. However, this is merely exemplary, and the opposite case may also be possible.

The RIS controller may decode the RIS control information based on the identified format of the RIS control information.

According to an embodiment, if it is identified that the format of the RIS control information is format 1, the RIS controller may expect that the RIS control information includes the following information.
Slot offset (┌log₂K_{RCI}┐ bits): The slot offset may indicate a difference in the slot number between the slot in which the RIS control information is received and the slot to which the reflection patterns are applied.
Information indicating reflection patterns of symbols (14·┌log₂M┐ bits): The information may include reflection pattern information being applied to the symbols included in the slot indicated by the slot offset. One of M RIS codeword indexes may be indicated in each symbol.

According to an embodiment, if it is identified that the format of the RIS control information is format 2, the RIS controller may expect that the RIS control information includes the following information.
Slot offset (┌log₂K_{RCI}┐ bits): The slot offset may indicate the difference in the slot number between the slot in which the RIS control information is received and the slot to which the reflection patterns are applied.
Information representing the time resource of the PDCCH (6 bits): The information representing the time resource of the PDCCH may represent the time resource on which the PDCCH is allocated in the slot indicated by the slot offset.
Information representing the time resource of the PDSCH (13 bits): The information representing the time resource of the PDSCH may represent the time resource allocated to the PDSCH scheduled by the PDCCH.
Information on the reflection patterns being applied to the control channel and the data channel (┌log₂M┐ bits): The information on the reflection patterns being applied to the control channel and the data channel may indicate the reflection patterns commonly applied to the control channel and the data channel.
Information on the reflection patterns being applied to the symbols except the symbols allocated to the control channel and the data channel ((14−α)·┌log₂M┐ bits): The information may indicate the reflection patterns being applied to the remaining symbols except the symbols allocated to the control channel and the data channel in the slot indicated by the slot offset.

According to an embodiment, if it is identified that the format of the RIS control information is format 2, the RIS controller may expect that the RIS control information further includes the following information. That is, in order to apply the reflection patterns of the PDCCH and the PDSCH even on the time resource on which a hybrid automatic repeat request-acknowledgement (HARQ-ACK) for the PDSCH is received, the following information for indicating the time resource on which the HARQ-ACK information is transmitted may be further included.
HARQ-ACK correlation indicator (1 bit): The HARQ-ACK correlation indicator may represent whether the RIS control information includes HARQ-ACK time resource information (e.g., PDSCH-HARQ feedback timing indicator and time resource information of PUCCH). For example, the HARQ-ACK correlation indicator that is set to 0 may represent that the RIS control information does not include the HARQ-ACK time resource information. Further, the HARQ-ACK correlation indicator that is set to 1 may represent that the RIS control information includes the HARQ-ACK time resource information. Finally, if the RIS control information format indicator and the HARQ-ACK correlation indicator are set to 1 in all, the RIS controller may expect that the RIS control information includes the HARQ-ACK time resource information.
PDSCH-HARQ feedback timing indicator (4 bits): The PDSCH-HARQ feedback timing indicator may indicate a slot offset K1. In this case, the slot offset K1 may mean the difference in the slot number between the slot allocated with the PDSCH and the slot allocated with the HARQ-ACK information for the PDSCH. For example, the slot offset K1 may have one value of 0 to 15. Accordingly, the PDSCH-HARQ feedback timing indicator may be composed of 4-bit information. For example, if the slot offset K1 is 2, the PDSCH-HARQ feedback timing indicator may be composed of bits of 0010. However, this is merely exemplary, and the range of the slot offset K1 may be variously defined in some cases.
PUCCH time resource information (7 bits): The PUCCH time resource information may indicate the time resource on which the HARQ-ACK information is allocated in the slot indicated by the PDSCH-HARQ feedback timing indicator. In this case, the number of possible combinations of start symbols (e.g., S=0, 1, . . . , 13) and symbol lengths (e.g., L=1, 2) defined in format 0 and format 2 of the PUCCH is 27, and the number of possible combinations of start symbols (e.g., S=0, 1, . . . , 10) and symbol lengths (e.g., L=4, 5, . . . , 14) defined in PUCCH formats 1, 3, and 4 is 66. Finally, since the number of possible combinations of the start symbols and the symbol lengths that can be allocated to the PUCCH is 93, the PUCCH time resource information may be composed of 7-bit information. However, this is merely exemplary, and the range of the start symbols and the symbol lengths of the PUCCH may be variously defined in some cases.

In step 630, the RIS controller may identify the reflection patterns of the symbols included in the slot.

According to an embodiment, if it is identified that the format of the RIS control information is format 1, the RIS controller may identify the slot to which the reflection patterns are applied based on the slot offset. For example, if the slot offset indicates 2, and the slot in which the RIS control information is received is slot n, the RIS controller may identify that the slot to which the reflection patterns are applied is slot n+2. Further, the RIS controller may identify the reflection patterns being applied to the respective symbols included in the corresponding slot based on the information indicating the reflection patterns of the symbols. For example, the RIS controller may identify the reflection patterns being applied to symbol 0, symbol 1, . . . , symbol 13 included in slot n+2.

According to an embodiment, if it is identified that the format of the RIS control information is format 2, the RIS controller may identify the slot to which the reflection patterns are applied based on the slot offset. For example, if the slot offset indicates 3, and the slot in which the RIS control information is received is slot n, the RIS controller may identify that the slot to which the reflection patterns are applied is slot n+3. Further, the RIS controller may identify the time resource of the PDCCH in the slot to which the reflection patterns are applied based on the information representing the time resource of the PDCCH. For example, if the bits of the information representing the time resource of the PDCCH are 000010, the RIS controller may identify that the start symbol of the PDCCH in slot n+3 is 0, and the symbol length of the PDCCH is 3.

Further, the RIS controller may identify the time resource allocated with the PDSCH being scheduled by the PDCCH based on the information representing the time resource of the PDSCH. For example, if the information representing the time resource of the PDSCH is composed of bits of 0000011011000, the RIS controller may identify that the 6 bits of 000001 indicate a PDCCH-to-PDSCH slot offset, and 7 bits of 1011000 represent a start symbol and length indicator value (SLIV). That is, the RIS controller may identify that the start symbol of the PDSCH is 4 in slot n+4, and the symbol length of the PDSCH is 7. Accordingly, the RIS controller may identify the time resource of the PDSCH to which the same reflection pattern as that of the PDCCH is applied. Further, the RIS controller may identify the reflection patterns commonly applied to the PDCCH and the PDSCH being scheduled by the PDCCH based on the information on the reflection patterns being applied to the control channel and the data channel.

For example, if the number of RIS codeword indexes is 8, and the information on the reflection patterns being applied to the control channel and the data channel is composed of bits of 001, the RIS controller may identify that the reflection patterns 4k corresponding to the first codeword index among 8 RIS codeword indexes are applied to symbols 0, 1, 2 of slot n+3 and symbols 4, 5, 6, 7, 8, 9, 10 of slot n+4. Based on the above-described method, the reflection patterns being applied to the PDSCH scheduled in slot n+4 may be the same as the reflection patterns of the PDCCH scheduling the corresponding PDSCH. Accordingly, the RIS controller may store the reflection patterns being applied to the symbols 4, 5, 6, 7, 8, 9, 10 of the slot n+4, and utilize the stored reflection patterns when controlling the reflection patterns for the slot n+4.

Further, the RIS controller may identify the reflection patterns of the symbols except the PDCCH and the PDSCH in the slot to which the reflection patterns are applied based on the information on the reflection patterns being applied to the symbols except the symbols allocated to the control channel and the data channel. For example, if the PDCCH of the slot n+3 is allocated to symbols 0, 1, 2, and the PDSCH is allocated to symbols 3, 4, 5, the RIS controller may identify the reflection patterns, the RIS controller may identify the reflection patterns of the symbols 6 to 13. According to an embodiment, if it is identified that the RIS control information includes the HARQ-ACK time resource information (e.g., PDSCH-HARQ feedback timing indicator and PUCCH time resource information) based on the HARQ-ACK correlation indicator, the RIS controller may identify the slot to which the HARQ-ACK information is transmitted based on the PDSCH-HARQ feedback timing indicator. Further, the RIS controller may identify the time resource on which the HARQ-ACK information is allocated in the slot indicated by the PDSCH-HARQ feedback timing indicator based on the PUCCH time resource information.

In this case, the RIS controller may identify the reflection patterns being applied on the time resource on which the HARQ-ACK information is allocated based on the information on the reflection patterns being applied to the control channel and the data channel. That is, according to the above-described method, since the same reflection pattern is applied to the three channels (PDCCH, PDSCH, and PUCCH), the overhead of the RIS control information can be reduced.

In step 640, the RIS controller may control the reflection plane of the RIS based on the identified reflection patterns.

Meanwhile, in Embodiment 1, although an example of utilizing the relationship between the PDCCH and the PDSCH has been described, the embodiments of the disclosure are not limited thereto. For example, in case that the PDCCH schedules the PUSCH, the embodiments of the disclosure may also utilize the relationship between the PDCCH and the PUSCH.

[Embodiment 2]

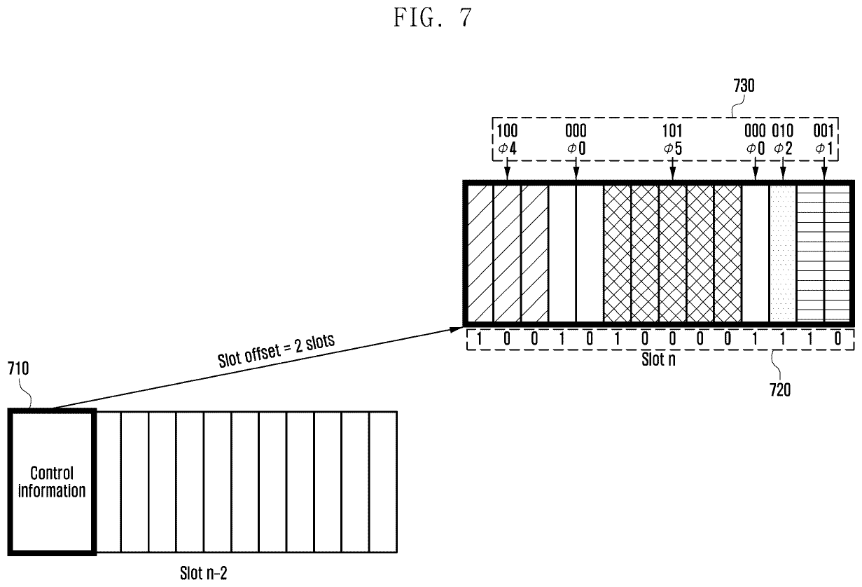

FIG. 7 illustrates reflection patterns according to embodiments of the present disclosure. With reference to FIG. 7, the number of bits required for the control information 710 to indicate the reflection patterns 730 will be described. In FIG. 7, it is assumed that a slot offset has one value of 0 to 31, and the number of RIS codeword indexes is 8.

With reference to FIG. 7, control information 710 may include at least one of information on the slot offset, information indicating symbol sets to which the same reflection pattern is applied, or information indicating the reflection patterns being applied to the symbol sets. Here, the control information 710 may be referred to as RIS control information (RCI).

First, the slot offset may mean a difference in the slot number between the slot in which the control information 710 is received and the slot to which the reflection patterns are applied. For example, with reference to FIG. 7, since the slot in which the control information 710 is received is slot n-2, and the slot offset is 2, it may mean that the reflection patterns indicated by the control information 710 are applied in slot n. In this case, since the slot offset is 2, the information on the slot offset may be composed of bits of 000010. That is, the information on the slot offset may be composed of 6-bit information. However, in this case, it is exemplified that the maximum value of the slot offset is 31, and in case that the slot offset indicates one value of 0 to KRCI-1, the information on the slot offset may be composed of information of ┌log₂K_{RCI}┐ bits.

Symbol sets to which the same reflection pattern is applied may be indicated in a toggle method. Since one slot includes 14 symbols, information indicating the symbol sets to which the same reflection pattern is applied may be composed of 14 bits. In this case, in the toggle method, the first symbol of the symbols to which the same reflection pattern is applied may have the value of 1, and the remaining symbols have the value of 0. For example, with reference to FIG. 7, since symbol 0, 3, 5, 10, 11, or 12 is the first symbol of each set, the information on the symbol sets to which the same reflection pattern is applied may be composed of bits 720 of 10010100001110. However, the above-described toggle method is merely exemplary, and embodiments of the disclosure are not limited thereto.

The information indicating the reflection patterns being applied to the symbol sets may indicate one of a plurality of RIS codewords, being configured through upper layer signaling (e.g., radio resource control (RRC)) for each symbol set. For example, with reference to FIG. 7, since the number of symbol sets is 6, and the number of RIS codeword indexes is 8, the information indicating the reflection patterns being applied to the symbol sets may be composed of 18 bits. In generalization, if the number of symbol sets is P, and the number of RIS codeword indexes is M, the information indicating the reflection patterns being applied to the symbol sets may be composed of P·┌log₂M┐ bits.

With reference to the above-described matters, in order to indicate the reflection patterns being applied to the symbols of a specific slot through the RIS control information 710, information of ┌log₂K_{RCI}┐+14+P·┌log₂M┐ bits is required. The format of the RIS control information generated in the described method with reference to FIG. 7 may be referred to as format 3.

In consideration of the point that the RIS control information 710 is generally transmitted through layer 1 (L1) signaling, it is required to reduce the overhead of pieces of information included in the RIS control information 710.

Hereinafter, in consideration of the point that related physical channels mostly perform communication by using the same beam in a wireless communication environment and timing relation is defined between the physical channels, schemes for reducing the overhead of the MS control information 710 rather than format 3 in a specified case will be described.

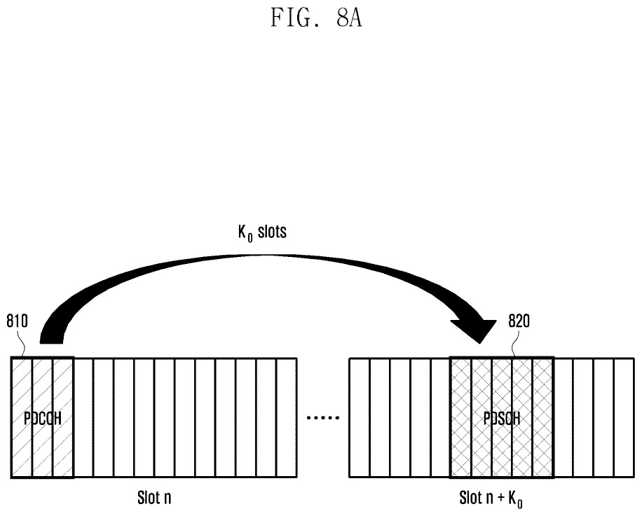

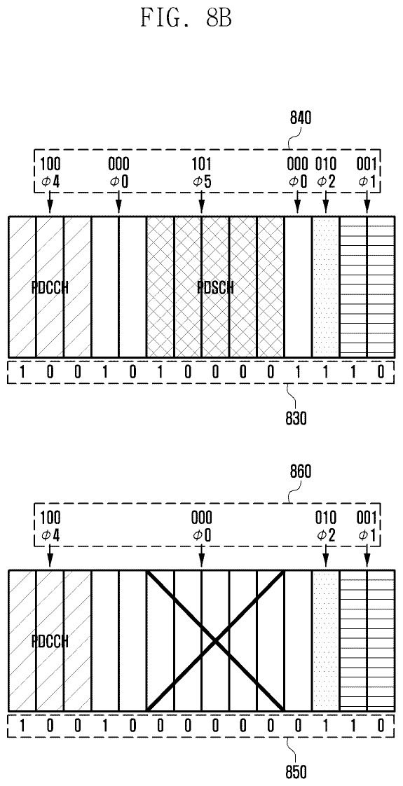

FIG. 8A illustrates reflection patterns according to embodiments of the present disclosure. With reference to FIG. 8A, the number of bits required to indicate reflection patterns of slot n will be described. That is, since PDSCH 820 being scheduled by PDCCH 810 and PDSCH 820 mostly use the same beam, the number of required bits in case that the same reflection pattern is applied to the PDCCH 810 and the PDSCH 820 will be described. Meanwhile, although not illustrated in FIG. 8A, it is assumed that the MS control information (RCI) is received before slot n. Further, it is assumed that the PDSCH allocated to slot n has already been indicated so that the same reflection pattern as that of the PDCCH that schedules the corresponding PDSCH is applied thereto.

The RIS control information may include information on a slot offset for reflection patterns, information representing a time resource of the PDSCH 820, information indicating symbol sets to which the same reflection pattern (except the PDSCH) is applied, information indicating reflection patterns being applied to the symbol sets, or information indicating the symbol set allocated with the PDCCH.

First, the slot offset for the reflection patterns may mean the difference in the slot number between the slot in which the RIS control information is received and the slot to which the reflection patterns are applied. For example, with reference to FIG. 8A, if the RIS control information is received in slot n-2, the information on the slot offset may indicate 2. Meanwhile, if the range of the slot offset for the reflection patterns is 0 to KRCI-1, the information on the slot offset for the reflection patterns may be composed of ┌log₂K_{RCI}┐-bit information.

As described above with reference to FIG. 2, the information representing the time resource of the PDSCH 820 may be composed of 13 bits.

Symbol sets to which the same reflection pattern is applied in the corresponding slot except the PDSCH may be indicated in the toggle method. Since one slot includes 14 symbols, information indicating the symbols to which the same reflection pattern is applied may be composed of 14 bits. In this case, in the toggle method, the first symbol of the symbols to which the same reflection pattern is applied except the PDSCH may have the value of 1, and the remaining symbols have the value of 0.

The information indicating the reflection patterns being applied to the symbol sets may indicate one of a plurality of RIS codewords configured through the upper layer signaling for each symbol set. For example, if the number of symbol sets is P′, and the number of RIS codeword indexes is M, the information indicating the reflection patterns being applied to the symbol sets may be composed of P′·┌log₂M┐ bits.

The information indicating the symbol set allocated with the PDCCH may indicate the symbol set allocated with the PDCCH among the plurality of symbol sets. For example, if the number of symbol sets is P′, the information indicating the symbol set allocated with the PDCCH may be composed of ┌log₂P′┐ bits.

In summarizing the above-described contents, in order to indicate the reflection patterns of the symbols included in slot n through the RIS control information, ┌log₂K_{RCI}┐+27+P′·┌log₂M┐+┌log₂P′┐ bits are required. In order to distinguish from format 3 as described above in FIG. 7, the format of the MS control information generated in the above-described method of FIG. 8A may be referred to as format 4.

FIG. 8B illustrates reflection patterns according to embodiments of the present disclosure. With reference to FIG. 8B, overheads of MS control information (RCI) of format 3 and format 4 are compared with each other. In FIG. 8B, it is assumed that the number M of MS codeword indexes is 8.

As described above in FIG. 7, the RIS control information of format 3 requires ┌log₂K_{RCI}┐+14+P·┌log₂M┐ bits. Further, as described above in FIG. 8A, the RIS control information of format 4 requires ┌log₂K_{RCI}┐+27+P′·┌log₂M┐+┌log₂P′┐ bits.

With reference to FIG. 8B, the MS control information of format 3 may include information on the slot offset, information indicating symbol sets to which the same reflection pattern is applied, and information indicating the reflection patterns being applied to the symbol sets. For example, the information indicating the symbol sets may be composed of bits 830 of 10010100001110. Further, the reflection pattern information being applied to the symbol sets may

In case of RIS control information of format 4, the RIS control information may include information on the slot offset, information indicating the time resource of the PDSCH being scheduled by the PDCCH, information indicating symbol sets to which the same reflection pattern is applied except the PDSCH of the slot indicated by the slot offset, information indicating the reflection patterns being applied to the symbol sets, and information indicating the symbol set allocated with the PDCCH. For example, the information indicating the symbol sets may be composed of bits 850 of 100100000000110. In this case, the PDSCH is not considered. Further, the reflection pattern information being applied to the symbol sets may be composed of bits 860 of 100000010001. Accordingly, in such an example, the RIS control information may include ┌log₂K_{RCI}┐+41 bits.

The number of required bits in accordance with the number M of RIS codeword indexes and the number P′ of symbol sets except the PDSCH may be represented as in Table 8 below. In Table 8, it is assumed that a format indicator (one bit) for distinguishing format 3 and format 4 from each other is added.

TABLE 8

| | | | The number | The range of P |
|---|---|---|---|---|
| The number | | The number of | of bits of | advantageous |
| of RIS | | bits of RIS control | RIS control | for format |
| codeword | | information of | information of | 4 method to |
| indexes | P′ | format 3 | format 4 | reduce overhead |
| 4 × M ≤ 8 | 2 | ┌log₂K_{RCI}┐ + 15 + 3P | ┌log₂K_{RCI}┐ + 35 | P ≥ 7 |
| | 4 | ┌log₂K_{RCI}┐ + 15 + 3P | ┌log₂K_{RCI}┐ + 42 | P ≥ 10 |
| | 6 | ┌log₂K_{RCI}┐ + 15 + 3P | ┌log₂K_{RCI}┐ + 49 | P ≥ 12 |
| 8 × M ≤ 16 | 2 | ┌log₂K_{RCI}┐ + 15 + 4P | ┌log₂K_{RCI}┐ + 37 | P ≥ 6 |
| | 4 | ┌log₂K_{RCI}┐ + 15 + 4P | ┌log₂K_{RCI}┐ + 46 | P ≥ 8 |
| | 6 | ┌log₂K_{RCI}┐ + 15 + 4P | ┌log₂K_{RCI}┐ + 55 | P ≥ 11 |
| 16 × M ≤ 32 | 2 | ┌log₂K_{RCI}┐ + 15 + 5P | ┌log₂K_{RCI}┐ + 39 | P ≥ 5 |
| | 4 | ┌log₂K_{RCI}┐ + 15 + 5P | ┌log₂K_{RCI}┐ + 50 | P ≥ 8 |
| | 6 | ┌log₂K_{RCI}┐ + 15 + 5P | ┌log₂K_{RCI}┐ + 61 | P ≥ 10 |

With reference to Table 8, it is advantageous in reducing the overhead to generate the RIS control information based on format 4 as the number M of RIS codeword indexes is larger. For example, if P′=2, M=8, and the number P of symbol sets is equal to or larger than 7, it is advantageous in reducing the overhead to generate the RIS control information based on format 4. In contrast, if P′=2, M=32, and the number P of symbol sets is equal to or larger than 5, it is advantageous in reducing the overhead to generate the RIS control information based on format 4. That is, as the number of RIS codeword indexes is larger, it can be identified that the range of P becomes wider. Further, with reference to Table 8, as the number of symbol sets except the PDSCH becomes smaller, it can be known that it is advantageous in reducing the overhead to generate the control information based on format 4. For example, if M=8, P′=6, and P is equal to or larger than 12, it is advantageous in reducing the overhead to generate the RIS control information based on format 4.

In contrast, if M=8, P′=2, and P is equal to or larger than 7, it is advantageous in reducing the overhead to generate the RIS control information based on format 4. That is, as the number of symbol sets except the PDSCH becomes smaller, it can be identified that the range of P becomes wider. An example in which the number of symbol sets except the PDSCH becomes smaller may be a case in which the PDSCH is allocated to several successive symbol sets in one slot. For example, a case in which the PDSCH is allocated to symbol 4-6 and symbol 8-10 may be the example. Further, the example in which the number of symbol sets except the PDSCH becomes smaller may be a case in which other signals (e.g., CSI-RS) except the PDCCH and the PDSCH are not allocated in the slot.

As described above with reference to FIG. 8B, one format of format 3 or format 4 may be advantageous in reducing the overhead of the RIS control information in accordance with the number M of MS codeword indexes and the number P′ of symbol sets except the PDSCH. Accordingly, hereinafter, a method for adaptively determining the format of the RIS control information based on the number M of RIS codeword indexes and the number P′ of symbol sets except the PDSCH will be described.

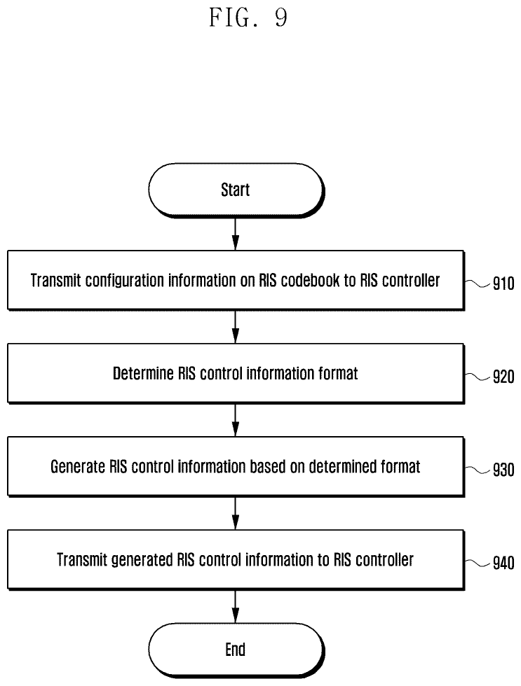

FIG. 9 illustrates an operation flow of a base station according to embodiments of the present disclosure. With reference to FIG. 9, a method for configuring an RIS controller (RC) by a base station so that the RIS controller can control reflection patterns of an MS will be described.

With reference to FIG. 9, in step 910, the base station may transmit configuration information on an MS codebook to the MS controller. The configuration information on the RIS codebook may include at least one of pieces of information on RIS codeword indexes or a plurality of reflection patterns corresponding to the MS codeword indexes. In this case, the information on the plurality of reflection patterns may include at least one of information on amplitudes or information on phases being applied to respective REs. For example, the configuration information on the MS codebook may be configured as in Table 6 above.

In step 920, the base station may determine an RIS control information format. In this case, the RIS control information format may be determined based on the number M of RIS codeword indexes and the number P′ of symbol sets except the PDSCH. In order to indicate the format of the RIS control information, one-bit information may be additionally required. For example, if the information indicating the format of the RIS control information is 0, it may represent that the RIS control information has been generated based on format 3. Further, if the information indicating the format of the RIS control information is 1, it may represent that the RIS control information has been generated based on format 4. In consideration of such added one bit, the number of bits required in the respective formats may be as in Table 9 below.

TABLE 9

| | |
|---|---|
| Format 3 | ┌log₂K_{RCI}┐ + 15 + P · ┌log₂M┐ |
| Format 4 | ┌log₂K_{RCI}┐ + 28 + P′ · ┌log₂M┐ + ┌log₂P′┐ |

Accordingly, if format 4 is more advantageous than format 3 in reducing the overhead, it may be a case in which Mathematical expression 5 below is satisfied.

$$P > \frac{⌈ {log}_{2} {P}^{′} ⌉ + 13}{⌈ {log}_{2} M ⌉} + {P}^{′} \qquad [ Mathematical expression 5 ]$$

Finally, if Mathematical expression 5 is not satisfied, the base station may determine to generate the MS control information of format 3. In contrast, if Mathematical expression 5 is satisfied, the base station may determine to generate the MS control information of format 4.

In step 930, the base station may generate the RIS control information based on the determined format.

According to an embodiment, if the RIS control information is generated based on format 3, the RIS control information may include the following information.
Slot offset (┌log₂K_{RCI}┐ bits): The slot offset may indicate a difference in the slot number between the slot in which the RIS control information is received and the slot to which the reflection patterns are applied.
RIS control information format indicator (1 bit): The RIS control information format indicator may indicate the RIS control information format. For example, if the RIS control information format indicator is 0, the RIS controller may identify that the RIS control information is generated based on format 3. Further, if the RIS control information format indicator is 1, the RIS controller may identify that the RIS control information is generated based on format 4. However, this is merely exemplary, and the opposite case may also be possible.
Symbol set indicator (14 bits): The symbol set indicator may indicate symbol sets to which the same reflection pattern is applied. The symbol sets may be indicated in a toggle method. For example, if the symbol set indicator is composed of bits of 10010000000000, it is able to be known that the number of symbol sets is 2, and the symbol sets are separated into a first symbol set (symbols 0 to 2) and a second symbol set (symbols 3 to 13).
Reflection pattern indicator (P·┌log₂M┐ bits): The reflection pattern indicator may indicate one of a plurality of RIS codewords configured through upper layer signaling with respect to the respective symbol sets.

According to an embodiment, in case that the RIS control information is generated based on format 4, the RIS control information may include the following information.
Slot offset (┌log₂K_{RCI}┐ bits): The slot offset may indicate a difference in the slot number between the slot in which the RIS control information is received and the slot to which the reflection patterns are applied.
RIS control information format indicator (1 bit): The RIS control information format indicator may indicate the RIS control information format. For example, if the RIS control information format indicator is 0, the RIS controller may identify that the RIS control information is generated based on format 3. Further, if the RIS control information format indicator is 1, the RIS controller may identify that the RIS control information is generated based on format 4. However, this is merely exemplary, and the opposite case may also be possible.
Information representing the time resource of the PDSCH (13 bits): The information representing the time resource of the PDSCH may represent the time resource allocated to the PDSCH scheduled by the PDCCH of the slot indicated by the slot offset.
Symbol set indicator (14 bits): The symbol set indicator may indicate symbol sets to which the same reflection pattern is applied except the PDSCH in the slot in the toggle method.
Reflection pattern indicator (P′·┌log₂M┐): The reflection pattern indicator may indicate one of a plurality of RIS codewords configured through upper layer signaling with respect to the respective symbol sets.
PDCCH Indicator (┌log₂P′┐): The PDCCH indicator may indicate the symbol set to which the PDCCH is allocated among the symbol sets.

According to an embodiment, the RIS control information being generated based on format 4 may further include the following information. That is, in order to apply the reflection patterns of the PDCCH and the PDSCH even on the time resource on which a hybrid automatic repeat request-acknowledgement (HARQ-ACK) for the PDSCH is received, the following information for indicating the time resource on which the HARQ-ACK information is transmitted may be further included.
HARQ-ACK correlation indicator (1 bit): The HARQ-ACK correlation indicator may represent whether the RIS control information includes HARQ-ACK time resource information (e.g., PDSCH-HARQ feedback timing indicator and time resource information of PUCCH). For example, the HARQ-ACK correlation indicator that is set to 0 may represent that the RIS control information does not include the HARQ-ACK time resource information. Further, the HARQ-ACK correlation indicator that is set to 1 may represent that the RIS control information includes the HARQ-ACK time resource information. However, this is merely exemplary, and the opposite case may also be possible. Finally, if the RIS control information format indicator and the HARQ-ACK correlation indicator are set to 1 in all, the RIS controller may expect that the RIS control information includes the HARQ-ACK time resource information.
PDSCH-HARQ feedback timing indicator (4 bits): The PDSCH-HARQ feedback timing indicator may indicate a slot offset K1. In this case, the slot offset Ki may mean the difference in the slot number between the slot allocated with the PDSCH and the slot allocated with the HARQ-ACK information for the PDSCH. For example, the slot offset K1 may have one value of 0 to 15. Accordingly, the PDSCH-HARQ feedback timing indicator may be composed of 4-bit information. For example, if the slot offset K1 is 2, the PDSCH-HARQ feedback timing indicator may be composed of bits of 0010. However, this is merely exemplary, and the range of the slot offset K1 may be variously defined in some cases.
PUCCH time resource information (7 bits): The PUCCH time resource information may indicate the time resource on which the HARQ-ACK information is allocated in the slot indicated by the PDSCH-HARQ feedback timing indicator. In this case, the number of possible combinations of start symbols (e.g., S=0, 1, . . . , 13) and symbol lengths (e.g., L=1, 2) defined in format 0 and format 2 of the PUCCH is 27, and the number of possible combinations of start symbols (e.g., S=0, 1, . . . , 10) and symbol lengths (e.g., L=4, 5, . . . , 14) defined in PUCCH formats 1, 3, and 4 is 66. Finally, since the number of possible combinations of the start symbols and the symbol lengths that can be allocated to the PUCCH is 93, the PUCCH time resource information may be composed of 7-bit information. However, this is merely exemplary, and the range of the start symbols and the symbol lengths of the PUCCH may be variously defined in some cases.

In step 940, the base station may transmit the generated RIS control information to the RIS controller.

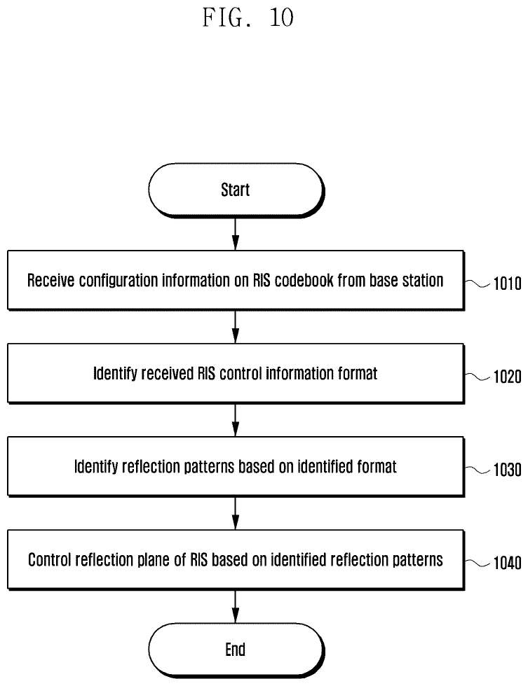

FIG. 10 illustrates an operation flow of an MS controller according to embodiments of the present disclosure. With reference to FIG. 10, a method for controlling MS reflection patterns by an MS controller (RC) will be described.

With reference to FIG. 10, in step 1010, the MS controller may receive configuration information on an MS codebook from the base station. The configuration information on the RIS codebook may include at least one of pieces of information on MS codeword indexes or a plurality of reflection patterns corresponding to the MS codeword indexes. In this case, the information on the plurality of reflection patterns may include at least one of information on amplitudes or information on phases being applied to respective REs. For example, the configuration information on the MS codebook may be configured as described above in Table 6 above.

In step 1020, the RIS controller may identify the format of the RIS control information. The RIS controller may receive the RIS control information from the base station. The RIS controller may identify the format of the RIS control information based on the RIS control information format indicator included in the RIS control information. Here, the format of the RIS control information may be composed of one bit. For example, if the RIS control information format indicator is 0, the RIS controller may identify that the format of the RIS control information is format 3. Further, if the RIS control information format indicator is 1, the RIS controller may identify that the format of the RIS control information is format 4. However, this is merely exemplary, and the opposite case may also be possible.

The RIS controller may decode the RIS control information based on the identified format of the RIS control information.

According to an embodiment, if it is identified that the format of the RIS control information is format 3, the RIS controller may expect that the RIS control information includes the following information.
Slot offset (┌log₂K_{RCI}┐ bits): The slot offset may indicate the difference in the slot number between the slot in which the RIS control information is received and the slot to which the reflection patterns are applied.
RIS control information format indicator (1 bit): The RIS control information format indicator may indicate the RIS control information format. For example, if the RIS control information format indicator is 0, the RIS controller may identify that the RIS control information is generated based on format 3. Further, if the RIS control information format indicator is 1, the RIS controller may identify that the RIS control information is generated based on format 4. However, this is merely exemplary, and the opposite case may also be possible.
Symbol set indicator (14 bits): The symbol set indicator may indicate the symbol sets to which the same reflection pattern is applied in the slot. The symbol sets may be indicated in the toggle method. For example, if the symbol set indicator is composed of bits of 10010000000000, it is able to be known that the number of symbol sets is 2, and the symbol sets are separated into the first symbol set (symbols 0 to 2) and the second symbol set (symbols 3 to 13).
Reflection pattern indicator (P·┌log₂M┐ bits): The reflection pattern indicator may indicate one of a plurality of RIS codewords configured through upper layer signaling with respect to the symbol sets.

According to an embodiment, if it is identified that the format of the RIS control information is format 4, the RIS controller may expect that the RIS control information includes the following information.
Slot offset (┌log₂K_{RCI}┐ bits): The slot offset may indicate the difference in the slot number between the slot in which the RIS control information is received and the slot to which the reflection patterns are applied.
RIS control information format indicator (1 bit): The RIS control information format indicator may indicate the RIS control information format. For example, if the RIS control information format indicator is 0, the RIS controller may identify that the RIS control information is generated based on format 3. Further, if the RIS control information format indicator is 1, the RIS controller may identify that the RIS control information is generated based on format 4. However, this is merely exemplary, and the opposite case may also be possible.
Information representing the time resource of the PDSCH (13 bits): The information representing the time resource of the PDSCH may represent the time resource allocated to the PDSCH scheduled by the PDCCH of the slot indicated by the slot offset.
Symbol set indicator (14 bits): The symbol set indicator may indicate symbol sets to which the same reflection pattern is applied except the PDSCH in the slot in the toggle method.
Reflection pattern indicator (P′·┌log₂M┐): The reflection pattern indicator may indicate one of the plurality of RIS codewords configured through upper layer signaling with respect to the symbol sets.
PDCCH Indicator (┌log₂P′┐): The PDCCH indicator may indicate the symbol set to which the PDCCH is allocated among the symbol sets.

According to an embodiment, if it is identified that the format of the RIS control information is format 4, the RIS controller may expect that the RIS control information further includes the following information. That is, in order to apply the reflection patterns of the PDCCH and the PDSCH even on the time resource on which the hybrid automatic repeat request-acknowledgement (HARQ-ACK) for the PDSCH is received, the following information for indicating the time resource on which the HARQ-ACK information is transmitted may be further included.
HARQ-ACK correlation indicator (1 bit): The HARQ-ACK correlation indicator may represent whether the RIS control information includes HARQ-ACK time resource information (e.g., PDSCH-HARQ feedback timing indicator and time resource information of PUCCH). For example, the HARQ-ACK correlation indicator that is set to 0 may represent that the RIS control information does not include the HARQ-ACK time resource information. Further, the HARQ-ACK correlation indicator that is set to 1 may represent that the RIS control information includes the HARQ-ACK time resource information. However, this is merely exemplary, and the opposite case may also be possible. Finally, if the RIS control information format indicator and the HARQ-ACK correlation indicator are set to 1 in all, the RIS controller may expect that the RIS control information includes the HARQ-ACK time resource information.
PDSCH-HARQ feedback timing indicator (4 bits): The PDSCH-HARQ feedback timing indicator may indicate a slot offset K1. In this case, the slot offset K1 may mean the difference in the slot number between the slot allocated with the PDSCH and the slot allocated with the HARQ-ACK information for the PDSCH. For example, the slot offset K1 may have one value of 0 to 15. Accordingly, the PDSCH-HARQ feedback timing indicator may be composed of 4-bit information. For example, if the slot offset K1 is 2, the PDSCH-HARQ feedback timing indicator may be composed of bits of 0010. However, this is merely exemplary, and the range of the slot offset K1 may be variously defined in some cases.
PUCCH time resource information (7 bits): The PUCCH time resource information may indicate the time resource on which the HARQ-ACK information is allocated in the slot indicated by the PDSCH-HARQ feedback timing indicator. In this case, the number of possible combinations of start symbols (e.g., S=0, 1, . . . , 13) and symbol lengths (e.g., L=1, 2) defined in format 0 and format 2 of the PUCCH is 27, and the number of possible combinations of start symbols (e.g., S=0, 1, . . . , 10) and symbol lengths (e.g., L=4, 5, . . . , 14) defined in PUCCH formats 1, 3, and 4 is 66. Finally, since the number of possible combinations of the start symbols and the symbol lengths that can be allocated to the PUCCH is 93, the PUCCH time resource information may be composed of 7-bit information. However, this is merely exemplary, and the range of the start symbols and the symbol lengths of the PUCCH may be variously defined in some cases.

In step 1030, the RIS controller may identify the reflection patterns of the identified format.

According to an embodiment, if it is identified that the format of the RIS control information is format 3, the RIS controller may identify the slot to which the reflection patterns are applied based on the slot offset. For example, if the slot offset indicates 2, and the slot in which the RIS control information is received is slot n, the RIS controller may identify that the slot to which the reflection patterns are applied is slot n+2. Further, the RIS controller may identify the symbol sets to which the same reflection pattern is applied based on the symbol set indicator. For example, if the symbol set indicator is composed of bits of 10011000000010, the RIS controller may identify that the first symbol set (symbols 0 to 2), the second symbol set (symbol 3), the third symbol set (symbols 4 to 11), and the fourth symbol set (symbols 12 to 13) exist in slot n+2. Further, the RIS controller may identify the reflection patterns being applied to the respective symbol sets based on the reflection pattern indicator. For example, the RIS controller may identify the first reflection pattern being applied to the first symbol set, the second reflection pattern being applied to the second symbol set, the third reflection pattern being applied to the third symbol set, and the fourth reflection pattern being applied to the fourth symbol set.

According to an embodiment, if it is identified that the format of the RIS control information is format 4, the RIS controller may identify the slot to which the reflection patterns are applied based on the slot offset. For example, if the slot offset indicates 3, and the slot in which the RIS control information is received is slot n, the RIS controller may identify that the slot to which the reflection patterns are applied is slot n+3. Further, the RIS controller may identify the symbol sets to which the same reflection pattern is applied except the PDSCH in the slot based on the symbol set indicator. For example, if the PDCCH is allocated to symbols 0 to 2, the PDSCH is allocated to symbols 4 to 11, and the CSI-RS is allocated to symbols 12 to 13, the symbol set indicator may be composed of bits of 10010000000010. In this case, the RIS controller may identify that the first symbol set (symbols 0 to 2), the second symbol set (symbols 3 to 11), and the third symbol set (symbols 12 to 13) exist.

Further, the RIS controller may identify the reflection patterns being applied to the respective symbol sets based on the reflection pattern indicator. For example, the RIS controller may identify the first reflection pattern being applied to the first symbol set, the second reflection pattern being applied to the second symbol set, and the third reflection pattern being applied to the third symbol set. In this case, the reflection patterns being applied to the PDSCH allocated to slot n+3 may have been obtained by the previous RIS control information. Further, if the PDCCH in slot n+3 schedules the PDSCH in the same slot, the RIS controller may apply the reflection patterns being applied to the PDCCH to the PDSCH. Accordingly, the RIS controller may identify the symbol set allocated with the PDCCH based on the PDCCH indicator. For example, if the PDCCH indicator is composed of bits of 00, the RIS controller may identify that the PDCCH is allocated to the first symbol set.

Further, the RIS controller may identify the time resource allocated with the PDSCH being scheduled by the PDCCH based on the information representing the time resource of the PDSCH. For example, if the PDCCH of slot n+3 schedules the PDSCH of slot n+4, the RIS controller may apply the same reflection patterns as those of the PDCCH of slot n+3 to the PDSCH of slot n+4. As another example, if the PDCCH of slot n+3 schedules the PDSCH in the same slot, the RIS controller may apply the same reflection patterns as those of the PDCCH of slot n+3 to the PDSCH of the same slot. According to an embodiment, if it is identified that the RIS control information includes the HARQ-ACK time resource information (e.g., PDSCH-HARQ feedback timing indicator and PUCCH time resource information) based on the HARQ-ACK correlation indicator, the RIS controller may identify the slot to which the HARQ-ACK information is transmitted based on the PDSCH-HARQ feedback timing indicator.

Further, the RIS controller may identify the time resource on which the HARQ-ACK information is allocated in the slot indicated by the PDSCH-HARQ feedback timing indicator based on the PUCCH time resource information. In this case, the RIS controller may identify the reflection patterns being commonly applied to the PDSCH and the PUCCH based on the reflection pattern indicator and the PDCCH indicator. That is, since the reflection patterns being applied on the time resource on which the HARQ-ACK information is allocated are in common with other channels (PDCCH and PDSCH), the overhead of the RIS control information can be reduced.

In step 1040, the RIS controller may control the reflection plane of the RIS based on the identified reflection patterns.

Meanwhile, in Embodiment 2, although an example of utilizing the relationship between the PDCCH and the PDSCH has been described, the embodiments of the disclosure are not limited thereto. For example, in case that the PDCCH schedules the PUSCH, the embodiments of the disclosure may also utilize the relationship between the PDCCH and the PUSCH.

Meanwhile, in the above description, although Embodiment 1 and Embodiment 2 are separately described, this is for convenience in explanation. In the embodiments of the disclosure, the RIS control information format indicator is composed of 2 bits, and thus it is also possible to operate the RIS control information of format 1, format 2, format 3, and format 4 together.

[Embodiment 3]

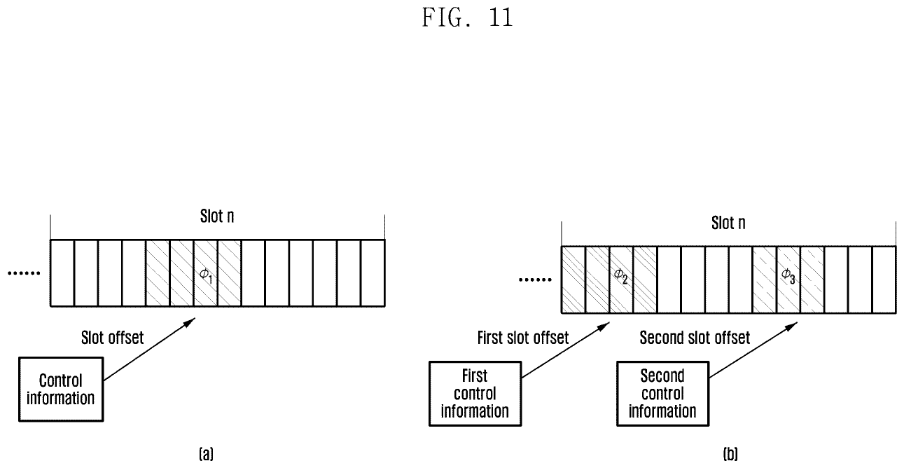

FIG. 11 illustrates reflection patterns according to embodiments of the present disclosure. With reference to FIG. 11, schemes for reducing the overhead of RIS control information (RCI) by not transmitting reflection pattern information with respect to a symbol duration in which a signal is not transmitted will be described.

With reference to FIG. 11(a), the RIS control information may indicate reflection patterns of slot n. For example, it may be assumed that the signal is transmitted only in successive symbols in slot n, and the signal is not transmitted in the remaining symbols. In this case, the RIS control information may include only information on the reflection patterns being allocated to the successive symbols (symbols 4, 5, 6, 7). In this case, the RIS control information may include the following information.
Slot offset (┌log₂K_{RCI}┐ bits): The slot offset may indicate the difference in the slot number between the slot in which the RIS control information is received and the slot to which the reflection patterns are applied. For example, in FIG. 11(a), if the RIS control information is received in slot n-2, the slot offset may indicate 2. In this case, if KRCI=4, the slot offset may be composed of 10 bits.
Start symbol and length indicator value (SLIV) (7 bits): The SLIV may indicate the time resource on which the successive symbols are allocated in slot n. That is, based on the SLIV, a start symbol S of the successive symbols and a length L of the successive symbols may be indicated.
Reflection pattern indicator (┌log₂M┐ bits): The reflection pattern indicator may indicate one of a plurality of RIS codeword indexes configured through upper layer signaling. In this case, the reflection patterns corresponding to the indicated RIS codeword indexes may be applied to the successive symbols.

Accordingly, if the RIS control information includes only the reflection pattern information on the symbols in which the signal is transmitted, the RIS control information may be composed of ┌log₂K_{RCI}┐+7+┌log₂M┐ bits. For example, in the example of FIG. 11(a), if KRCI=4, and the number M of MS codeword indexes is M=8, the MS control information may be composed of 12 bits.

With reference to FIG. 11(b), a method for indicating, if a plurality of sets of successive symbols exist in one slot, reflection patterns through a plurality of pieces of MS control information will be described. With reference to FIG. 11(b), in slot n, it may be assumed that the signal is transmitted only in the first symbol set (symbols 0 to 3) and the first symbol set (symbol 8 to 10), and the signal is not transmitted in other symbols. In this case, the reflection patterns being applied to the first symbol set through the first control information may be indicated, and the reflection patterns being applied to the second symbol set through the second control information may be indicated. In this case, if it is assumed that KRCI=4, and the number M of RIS codeword indexes is M=8, bits required for the RIS control information are as in Table 10 below.

TABLE 10

| | | RIS reflection | |
|---|---|---|---|
| | Slot offset | pattern | SLIV |
| First control information | 11(2 bits) | 010(3 bits) | 0101010(7 bits) |
| Second control information | 01(2 bits) | 011(3bits) | 0100100(7 bits) |

Finally, the total number of bits required for the RIS control information may be 24.

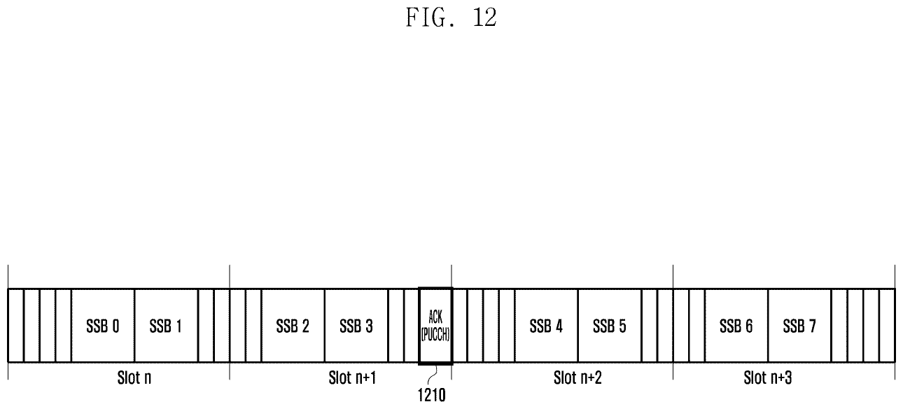

FIG. 12 illustrates reflection patterns according to embodiments of the present disclosure. With reference to FIG. 12, schemes for reducing the overhead of RIS control information in case that a periodic signal and an aperiodic signal coexist will be described. With reference to FIG. 12, a method for configuring the RIS reflection patterns in case that a synchronization signal block (SSB) for synchronization is periodically transmitted, and an aperiodic signal (e.g., hybrid automatic repeat request-acknowledgement (HARQ-ACK) is scheduled in slot n+1.

In case of the periodic signal, the base station may transmit the MS configuration information to the MS controller through upper layer signaling (e.g., radio resource control (RRC)).

According to an embodiment, the MS configuration information may include the following information.
Timing offset: The timing offset may indicate a time point to apply the reflection patterns. In this case, the timing offset may be indicated based on at least one of a system frame number (SFN), a subframe number, or a slot number.
Information on a period: The information on a period may indicate a period in which a periodic signal is transmitted.
SLIV: The SLIV may indicate a start symbol and a symbol length being allocated in one slot.
Reflection pattern indicator: The reflection pattern indicator may indicate one of a plurality of RIS codewords configured through upper layer signaling.

According to an embodiment, the RIS configuration information may include the information on the period, SLIV, and reflection pattern indicator only among the above-described information. In this case, the base station may indicate the time point to apply the reflection pattern to the RIS controller through a medium access control-control element (MAC CE). Such a MAC CE may be referred to as a reflection pattern activation MAC CE. Further, the base station may also indicate the time point to release the reflection pattern application to the RIS controller through a MAC CE. Such a MAC CE may be referred to as a reflection pattern deactivation MAC CE.

In case of the aperiodic signal, the information on the reflection patterns may be indicated to the RIS controller by using the method as described above with reference to FIG. 11.

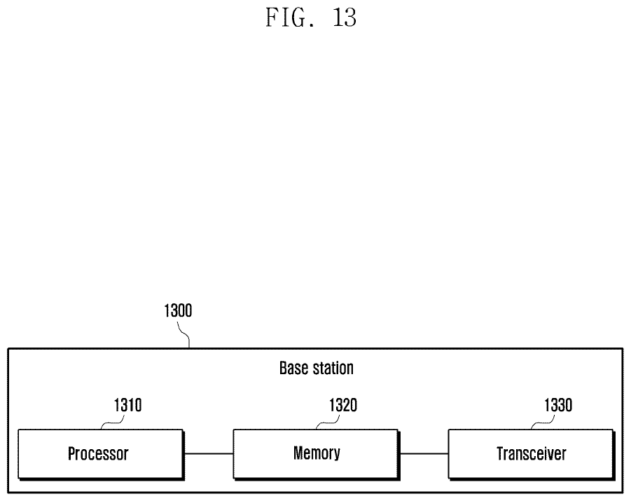

FIG. 13 illustrates the constitution of a base station according to embodiments of the present disclosure. With reference to FIG. 13, a base station may include a processor 1310, a memory 1320, and a transceiver 1330.

The processor 1310 may control the overall operation of the base station. For example, the processor 1310 may transmit and receive signals through the transceiver 1330. Further, the processor 1310 may perform functions of a protocol stack required in the communication standards. For this, the processor 1310 may include at least one processor. Further, the processor 1310 may control the base station to perform the operations according to the embodiments as described above.

The memory 1320 may store a basic program for an operation of the base station, application programs, and data, such as configuration information. The memory 1320 may be composed of a volatile memory, a nonvolatile memory, or a combination of the volatile memory and the nonvolatile memory. The memory 1320 may provide the stored data in accordance with a request from the processor 1310.

The transceiver 1330 may perform functions for transmitting and receiving signals through a wired channel or a wireless channel. For example, the transceiver 1330 may perform a conversion function between a baseband signal and a bit string in accordance with the physical layer standard of the system. For example, during data transmission, the transceiver 1330 may generate complex symbols by encoding and modulating a transmission bit string. Further, during data reception, the transceiver 1330 may restore a reception bit string through demodulating and decoding the baseband signal. Further, the transceiver 1330 may perform up-conversion of the baseband signal into a radio frequency (RF) band signal to transmit the RF band signal through an antenna, and perform down-conversion of the RF band signal being received through the antenna into a baseband signal. For this, the transceiver 1330 may include a transmission filter, a reception filter, an amplifier, a mixer, an oscillator, a digital-to-analog converter (DAC), and an analog-to-digital converter (ADC).

Further, the transceiver 1330 may include an antenna part. The transceiver 1330 may include at least one antenna array composed of a plurality of antenna elements. In terms of hardware, the transceiver 1330 may be composed of a digital and analog circuit (e.g., radio frequency integrated circuit (RFIC)). Here, the digital and analog circuit may be implemented by one package. Further, the transceiver 1330 may include a plurality of RF chains. Further, the transceiver 1330 may transmit and receive signals. For this, the transceiver 1330 may include at least one transceiver.

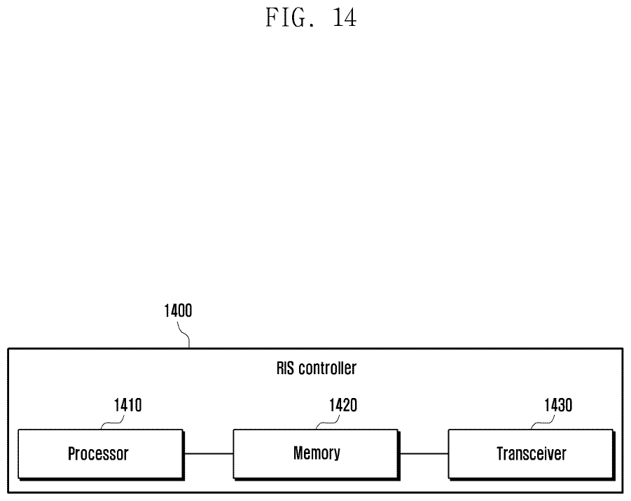

FIG. 14 illustrates the constitution of an RIS controller according to embodiments of the present disclosure. With reference to FIG. 14, an RIS controller may include a processor 1410, a memory 1420, and a transceiver 1430.

The processor 1410 may control the overall operation of the RIS controller. For example, the processor 1410 may transmit and receive signals through the transceiver 1430. Further, the processor 1410 may perform functions of a protocol stack required in the communication standards. For this, the processor 1410 may include at least one processor. Further, the processor 1410 may control the RIS controller to perform the operations according to the embodiments as described above.

The memory 1420 may store a basic program for an operation of the MS controller, application programs, and data, such as configuration information. The memory 1420 may be composed of a volatile memory, a nonvolatile memory, or a combination of the volatile memory and the nonvolatile memory. The memory 1420 may provide the stored data in accordance with a request from the processor 1410.

The transceiver 1430 may perform functions for transmitting and receiving signals through a wired channel or a wireless channel. For example, the transceiver 1430 may perform a conversion function between a baseband signal and a bit string in accordance with the physical layer standard of the system. For example, during data transmission, the transceiver 1430 may generate complex symbols by encoding and modulating a transmission bit string. Further, during data reception, the transceiver 1430 may restore a reception bit string through demodulating and decoding the baseband signal. Further, the transceiver 1430 may perform up-conversion of the baseband signal into a radio frequency (RF) band signal to transmit the RF band signal through an antenna, and perform down-conversion of the RF band signal being received through the antenna into a baseband signal. For this, the transceiver 1430 may include a transmission filter, a reception filter, an amplifier, a mixer, an oscillator, a digital-to-analog converter (DAC), and an analog-to-digital converter (ADC). Further, the transceiver 1430 may include an antenna part. The transceiver 1430 may include at least one antenna array composed of a plurality of antenna elements. In terms of hardware, the transceiver 1430 may be composed of a digital and analog circuit (e.g., radio frequency integrated circuit (RFIC)). Here, the digital and analog circuit may be implemented by one package. Further, the transceiver 1430 may include a plurality of RF chains. Further, the transceiver 1430 may transmit and receive signals. For this, the transceiver 1430 may include at least one transceiver.

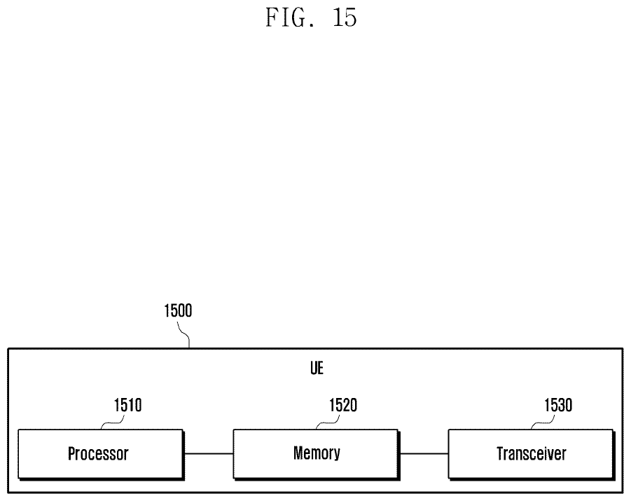

FIG. 15 illustrates the constitution of a UE according to embodiments of the present disclosure. With reference to FIG. 15, a UE may include a processor 1510, a memory 1520, and a transceiver 1530.

The processor 1510 may control the overall operation of the UE. For example, the processor 1510 may transmit and receive signals through the transceiver 1530. Further, the processor 1510 may perform functions of a protocol stack required in the communication standards. For this, the processor 1510 may include at least one processor. Further, the processor 1510 may control the UE to perform the operations according to the embodiments as described above.

The memory 1520 may store a basic program for an operation of the UE, application programs, and data, such as configuration information. The memory 1520 may be composed of a volatile memory, a nonvolatile memory, or a combination of the volatile memory and the nonvolatile memory. The memory 1520 may provide the stored data in accordance with a request from the processor 1510.

The transceiver 1530 may perform functions for transmitting and receiving signals through a wired channel or a wireless channel. For example, the transceiver 1530 may perform a conversion function between a baseband signal and a bit string in accordance with the physical layer standard of the system. For example, during data transmission, the transceiver 1530 may generate complex symbols by encoding and modulating a transmission bit string. Further, during data reception, the transceiver 1530 may restore a reception bit string through demodulating and decoding the baseband signal. Further, the transceiver 1530 may perform up-conversion of the baseband signal into a radio frequency (RF) band signal to transmit the RF band signal through an antenna, and perform down-conversion of the RF band signal being received through the antenna into a baseband signal. For this, the transceiver 1530 may include a transmission filter, a reception filter, an amplifier, a mixer, an oscillator, a digital-to-analog converter (DAC), and an analog-to-digital converter (ADC). Further, the transceiver 1530 may include an antenna part. The transceiver 1530 may include at least one antenna array composed of a plurality of antenna elements. In terms of hardware, the transceiver 1530 may be composed of a digital and analog circuit (e.g., radio frequency integrated circuit (RFIC)). Here, the digital and analog circuit may be implemented by one package. Further, the transceiver 1530 may include a plurality of RF chains. Further, the transceiver 1530 may transmit and receive signals. For this, the transceiver 1530 may include at least one transceiver.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

The methods according to claims of the disclosure and embodiments described in the description may be implemented in the form of hardware, software, or a combination of hardware and software.

In case of implementation by software, a computer readable storage medium storing one or more programs (software modules) may be provided. One or more programs stored in the computer readable storage medium are configured for execution by one or more processors in an electronic device. The one or more programs include instructions that cause the electronic device to execute the methods according to the claims of the disclosure or embodiments described in the description.

Such a program (software module or software) may be stored in a nonvolatile memory including a random access memory and a flash memory, a read only memory (ROM), an electrically erasable programmable read only memory (EEPROM), a magnetic disc storage device, a compact disc-ROM (CD-ROM), a digital versatile discs (DVDs) or other types of optical storage devices, or a magnetic cassette. Further, the program may be stored in a memory composed of a combination of parts or the whole of them. Further, a plurality of memories may be included.

Further, the program may be stored in an attachable storage device that can be accessed through a communication network such as Internet, Intranet, local area network (LAN), wide LAN (WLAN), or storage area network (SAN) or a communication network composed of a combination thereof. The storage device may be accessed by a device that performs embodiments of the disclosure through an external port. Further, a separate storage device on the communication network may access a device that performs embodiments of the disclosure.

In the above-described detailed embodiments of the disclosure, the elements included in the disclosure may be expressed in the singular or plural form depending on the provided detailed embodiment. However, the singular or plural expression has been selected suitably for a situation provided for convenience of description, and the disclosure is not limited to the singular or plural elements. Although an element has been expressed in the plural form, it may be configured in the singular form. Although an element has been expressed in the singular form, it may be configured in the plural form.

Although the detailed embodiments of the disclosure have been described in the detailed description of the disclosure, the disclosure may be modified in various ways without departing from the scope of the disclosure. Accordingly, the scope of the disclosure should not be limited to the above-described embodiments, but should be defined by not only the claims but also equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a base station in a wireless communication system, the method comprising:
transmitting, to a reconfigurable intelligence surface (RIS) controller, a radio resource control (RRC) message including RIS codebook configuration information;
determining a format of RIS control information based on a number of RIS codeword indexes;
generating the RIS control information based on the determined format of the RIS control information; and
transmitting, to the RIS controller, the generated RIS control information.

2. The method of claim 1, wherein the RIS control information includes information indicating a slot and a format indicator,
wherein the format of the RIS control information includes a first format and a second format, and
wherein the format of the RIS control information is determined based on the number of the RIS codeword indexes and a number of symbols allocated to a control channel of the slot and a first data channel of the slot.

3. The method of claim 2, wherein the RIS control information generated based on the first format includes reflection pattern information on symbols included in the slot,
wherein the RIS control information generated based on the second format includes first reflection pattern information and second reflection pattern information,
wherein the first reflection pattern information is related to the control channel and a second data channel being scheduled by the control channel, and
wherein the second reflection pattern information is related to the control channel and remaining symbols except the symbols allocated to the first data channel in the slot.

4. The method of claim 1, wherein the RIS control information includes information indicating a slot and a format indicator,
wherein the format of the RIS control information includes a third format and a fourth format,
wherein the format is determined based on the number of the RIS codeword indexes and a number of first symbol sets of the slot, and
wherein a first data channel of the slot is not included in the first symbol sets.

5. The method of claim 4, wherein the RIS control information generated based on the third format includes information indicating a second symbol sets of the slot and reflection pattern information related to the second symbol sets,
wherein the RIS control information generated based on the fourth format includes information indicating the first symbol sets, reflection pattern information related to the first symbol sets, information indicating the symbol set allocated with a control channel among the first symbol sets, and information indicating a time resource of a second data channel scheduled by the control channel,
wherein a same reflection pattern is applied to the control channel and the second data channel, and
wherein the first symbol sets or the second symbol sets are identified based on whether the same reflection pattern is applied to the slot.

6. A method performed by a reconfigurable intelligence surface (RIS) controller in a wireless communication, the method comprising:
receiving, from a base station, a radio resource control (RRC) message including RIS codebook configuration information;
receiving, from the base station, RIS control information including a format indicator and information indicating a slot;
identifying a format of the RIS control information based on the format indicator;
identifying reflection patterns related to symbols of the slot based on the RIS control information; and
controlling a reflection plane of an RIS based on the identified reflection patterns.

7. The method of claim 6, wherein the format of the RIS control information includes a first format and a second format, and
wherein the format of the RIS control information is determined based on a number of RIS codeword indexes and a number of symbols allocated to a control channel of the slot and a first data channel of the slot.

8. The method of claim 7, wherein the RIS control information includes reflection pattern information on symbols included in the slot in case that the format is the first format,
wherein the RIS control information includes first reflection pattern information and second reflection pattern information in case that the format is the second format,
wherein the first reflection pattern information is related to the control channel and a second data channel being scheduled by the control channel, and
wherein the second reflection pattern information is related to the control channel and remaining symbols except the symbols allocated to the first data channel in the slot.

9. The method of claim 6, wherein the format of the RIS control information includes a third format and a fourth format,
wherein the format is determined based on a number of RIS codeword indexes and a number of first symbol sets of the slot, and
wherein a first data channel of the slot is not included in the first symbol sets.

10. The method of claim 9, wherein the RIS control information includes information indicating a second symbol sets of the slot and reflection pattern information related to the second symbol sets in case that the format is the third format,
wherein the RIS control information includes information indicating the first symbol sets, reflection pattern information related to the first symbol sets, information indicating the symbol set allocated with a control channel among the first symbol sets, and information indicating a time resource of a second data channel scheduled by the control channel in case that the format is the fourth format,
wherein a same reflection pattern is applied to the control channel and the second data channel, and
wherein the first symbol sets or the second symbol sets are identified based on whether the same reflection pattern is applied to the slot.

11. A base station in a wireless communication system, the base station comprising:
a transceiver; and
a processor operably connected to the transceiver, wherein the processor is configured to:
transmit, to a reconfigurable intelligence surface (RIS) controller, a radio resource control (RRC) message including RIS codebook configuration information,
determine a format of RIS control information based on a number of RIS codeword indexes,
generate the RIS control information based on the determined format of the RIS control information, and
transmit, to the RIS controller, the generated RIS control information.

12. The base station of claim 11, wherein the RIS control information includes information indicating a slot and a format indicator,
wherein the format of the RIS control information includes a first format and a second format, and
wherein the format of the RIS control information is determined based on the number of the RIS codeword indexes and a number of symbols allocated to a control channel of the slot and a first data channel of the slot.

13. The base station of claim 12, wherein the RIS control information generated based on the first format includes reflection pattern information on symbols included in the slot,
wherein the RIS control information generated based on the second format includes first reflection pattern information and second reflection pattern information,
wherein the first reflection pattern information is related to the control channel and a second data channel being scheduled by the control channel, and
wherein the second reflection pattern information is related to the control channel and remaining symbols except the symbols allocated to the first data channel in the slot.

14. The base station of claim 11, wherein the RIS control information includes information indicating a slot and a format indicator,
wherein the format of the RIS control information includes a third format and a fourth format,
wherein the format is determined based on the number of the RIS codeword indexes and a number of first symbol sets of the slot, and
wherein a first data channel of the slot is not included in the first symbol sets.

15. The base station of claim 14, wherein the RIS control information generated based on the third format includes information indicating a second symbol sets of the slot and reflection pattern information related to the second symbol sets,
wherein the RIS control information generated based on the fourth format includes information indicating the first symbol sets, reflection pattern information related to the first symbol sets, information indicating the symbol set allocated with a control channel among the first symbol sets, and information indicating a time resource of a second data channel scheduled by the control channel,
wherein a same reflection pattern is applied to the control channel and the second data channel, and
wherein the first symbol sets or the second symbol sets are identified based on whether the same reflection pattern is applied to the slot.

16. A reconfigurable intelligence surface (RIS) controller in a wireless communication system, the RIS controller comprising:
a transceiver; and
a processor operably connected to the transceiver, wherein the processor is configured to:
receive, from a base station, a radio resource control (RRC) message including RIS codebook configuration information,
receive, from the base station, RIS control information including a format indicator and information indicating a slot,
identify a format of the RIS control information based on the format indicator,
identify reflection patterns related to symbols of the slot based on the RIS control information, and
control a reflection plane of an RIS based on the identified reflection patterns.

17. The RIS controller of claim 16, wherein the format of the RIS control information includes a first format and a second format, and
wherein the format of the RIS control information is determined based on a number of RIS codeword indexes and a number of symbols allocated to a control channel of the slot and a first data channel of the slot.

18. The RIS controller of claim 17, wherein the RIS control information includes reflection pattern information on symbols included in the slot in case that the format is the first format,
wherein the RIS control information includes first reflection pattern information and second reflection pattern information in case that the format is the second format,
wherein the first reflection pattern information is related to the control channel and a second data channel being scheduled by the control channel, and
wherein the second reflection pattern information is related to the control channel and remaining symbols except the symbols allocated to the first data channel in the slot.

19. The RIS controller of claim 16, wherein the format of the RIS control information includes a third format and a fourth format,
wherein the format is determined based on a number of codeword indexes and a number of first symbol sets of the slot, and
wherein a first data channel of the slot is not included in the first symbol sets.

20. The RIS controller of claim 19, wherein the RIS control information includes information indicating a second symbol sets of the slot and reflection pattern information related to the second symbol sets in case that the format is the third format,
wherein the RIS control information includes information indicating the first symbol sets, reflection pattern information related to the first symbol sets, information indicating the symbol set allocated with a control channel among the first symbol sets, and information indicating a time resource of a second data channel scheduled by the control channel in case that the format is the fourth format,
wherein a same reflection pattern is applied to the control channel and the second data channel, and
wherein the first symbol sets or the second symbol sets are identified based on whether the same reflection pattern is applied to the slot.
